(19) United States
(12) Patent Application Publication
(10) Pub. No.: US 2026/0098645 A1
(43) Pub. Date: Apr. 9, 2026

(54) GRIDDLE AND STAND SYSTEM

(71) Applicant: Solo Brands, LLC, Grapevine, TX (US)

(72) Inventors: Alexander K. Maghsadi, Fort Worth, TX (US); John L. Zivich, Dallas, TX (US); Josiah A. Wilhelm, Fort Worth, TX (US); Benjamin C. Loveall, Dallas, TX (US)

(21) Appl. No.: 19/350,808

(22) Filed: Oct. 6, 2025

Related U.S. Application Data
(63) Continuation-in-part of application No. 30/011,195, filed on Jul. 2, 2025, now Pat. No. D1108197.
(60) Provisional application No. 63/705,407, filed on Oct. 9, 2024.
(60) Provisional application No. 63/821,761, filed on Jun. 11, 2025.

(51) Int. Cl. F24C 3/14; A47J 37/06; A47J 37/07; F24C 15/08; F24C 15/10; F24C 15/12

(52) U.S. Cl. CPC F24C 3/14; A47J 37/0682; A47J 37/0713; A47J 37/0763; A47J 37/0786; F24C 15/08; F24C 15/107; F24C 15/12; A47J 2037/0795

(57) ABSTRACT

A cooking apparatus may include a main body. A substantially solid cooking surface may be coupled to the main body. A lid may also be coupled to the main body. A cavity may be positioned above the substantially solid cooking surface when the lid is in a closed position. A first opening may open into the cavity. The first opening may be configured to allow heated air to circumvent the substantially solid cooking surface and to flow into the cavity.

### PRIORITY

This application claims priority and the benefit of the filing date of U.S. Provisional Application 63/821,761, filed Jun. 11, 2025, titled, “Multi-Use Cooking System,”and U.S. Provisional Application 63/705,407, filed Oct. 9, 2024, titled, “Multi-Use Cooking System,” and U.S. Design Application 30/011,195, filed Jul. 2, 2025, titled, “Cooking Appliance,” the entire disclosures of which are hereby incorporated herein by reference.

### CROSS-REFERENCE TO RELATED APPLICATIONS

This application is related to U.S. patent application Ser. No. 29/967,329, filed Oct. 9, 2024, entitled COOKING APPLIANCE, the entire disclosure of which is hereby incorporated herein by reference. This application is also related to U.S. patent application Ser. No. 29/967,337, filed Oct. 9, 2024, entitled COOKING SYSTEM, the entire disclosure of which is hereby incorporated herein by reference.

### TECHNICAL FIELD

The present disclosure relates generally to cooking systems such as griddles, grills, stoves, pans and other cooking devices, and more particularly to systems, devices, and methods for a multi-use cooking system.

### BACKGROUND

A cooking system equipped for multiple uses may provide numerous benefits such as requiring less storage space than multiple single-use systems and generally lower costs compared to purchase costs of multiple single-use systems. Such multi-use systems beneficially sustain various integrated features but often come with drawbacks of reduced optimization due to the interchangeable components. For example, it can be difficult to optimize a cooking system equipped with interchangeable cooking surfaces, such as grills and griddles. Griddles are sometimes preferred over grills for many reasons, such as portability, indoor-outdoor versatility, even cooking heat, and increased safety. However, grills and griddles operate at significantly different temperatures. Simply replacing a grill surface with a griddle surface may risk overcooked and charred food. Griddles typically operate at temperatures around 350 degrees Fahrenheit while grills operate typically at around 400 degrees Fahrenheit or higher. For another example, it can be challenging to create a cooking system equipped for both portability and stationary use. Since cooking systems often involve gas-fueling, open flames, and hot food, failed integration between a portable cooking apparatus and a stand may present safety risks or create a poor user experience. Additionally, the portable cooking apparatus must be prepared to operate with the same safety features while functioning independently of the stand. Thus, there remains a need for effective ways for optimizing features of a multi-use cooking system.

### SUMMARY

Embodiments of the present disclosure include systems, devices, and methods of optimizing features of a multi-use cooking system.

In some examples, a cooking apparatus may include a main body. The cooking apparatus may further include a substantially solid cooking surface coupled to the main body. The cooking apparatus may further include a lid coupled to the main body. The cooking apparatus may further include a cavity positioned above the substantially solid cooking surface when the lid is in a closed position. The cooking apparatus may further include a first opening that opens into the cavity, the first opening configured to allow heated air to circumvent the substantially solid cooking surface and to flow into the cavity.

In some examples, A cooking apparatus may include a main body. The cooking apparatus may further include a substantially solid cooking surface coupled to the main body, the substantially solid cooking surface comprising a first layer, a second layer, and a third layer. The cooking apparatus may further include a lid coupled to the main body. The cooking apparatus may further include a lower cavity positioned below the substantially solid cooking surface and an upper cavity positioned above the substantially solid cooking surface when the lid is in a closed position, the substantially solid cooking surface extending at least partially between the upper cavity and the lower cavity and creating a thermal differential between the upper cavity and the lower cavity.

In some examples, a cooking system may include a portable gas-fired cooking apparatus. The cooking system may further include a stand comprising a top surface and configured to support the portable gas-fired cooking apparatus, the stand comprising a plurality of supports spaced a distance apart from the top surface, the stand configured to support the portable gas-fired cooking apparatus at at least four points of contact, the stand further comprising a plurality of members extending upwardly. The portable gas-fired cooking apparatus may be configured to rest on the plurality of supports between the plurality of members.

In some examples, a griddle cooking apparatus with dual-action control and a gas-flame safety shield may include a main body. The griddle cooking apparatus may further include a substantially solid cooking surface disposed in the main body. The griddle cooking apparatus may further include a piezo igniter positioned within the main body below the substantially solid cooking surface. The griddle cooking apparatus may further include a plurality of burners positioned within the main body below the substantially solid cooking surface, the piezo igniter being configured to ignite gas from the plurality of burners, the piezo igniter and the plurality of burners being positioned at a location not exposed to and visible to a user from above the main body, the piezo igniter being positioned at a location not exposed to and visible to the user from the sides of the main body, the plurality of burners being at least partially visible through at least one view hole in the side of the main body, the at least one view hole being positioned a distance apart from the plurality of burners. The griddle cooking apparatus may further include a dual-action control configured to actuate the piezo igniter and the burners in one continuous movement.

In some examples, an adjustable cooking apparatus with an integrated stabilizer may include a main body, the integrated stabilizer coupled to the main body. The adjustable cooking apparatus may further include a griddle coupled to the main body, the griddle having a griddle surface. The adjustable cooking apparatus may further include a stand configured to support the main body, the integrated stabilizer configured to adjust the angle and height of the griddle surface relative to level while the griddle is being supported by the stand.

In some examples, a contoured griddle cooking apparatus may include a contoured main body being devoid of corners and comprising a first curved end and a second curved end. The contoured griddle cooking apparatus may further include a contoured griddle cooking pan being devoid of corners and comprising a first curved end and a second curved end. The contoured griddle cooking apparatus may further include at least one contoured burner positioned within the contoured main body and having at least one curved portion, the contour of the burner configured to be substantially corresponding with the contour of the contoured main body and the contour of the cooking pan.

In some examples, a cooking grate with an integrated safety shield for at least one burner, the cooking grate may include a grill surface. The cooking grate may further include the integrated safety shield integrated with the grill surface and configured to be positioned at least partially between the grill surface and the at least one burner and configured to prevent grease from dripping on the at least one burner.

In some examples, a stand for a portable cooking apparatus with integrated gas-tank loading, the stand may include a main body. The stand may further include a support structure configured to support the main body. The stand may further include a main cavity positioned within the support structure. The stand may further include at least one burner positioned within the main body. The stand may further include an integrated loading member configured to pivot and being hingedly connected to the support structure, the integrated loading member configured to move between an open position and a closed position, wherein, when transitioning from the open position to the closed position the integrated loading member is configured to move a fuel tank into the main cavity of the stand.

In some examples, a griddle with a pivoting lid may include a griddle surface. The griddle may further include a main body having at least one hinge, the pivoting lid hingedly connected to the main body and configured to transition between an insulating position, a venting position, and a breakout position. In the insulating position, the pivoting lid at least partially may contain heated air in a cavity above the griddle surface. In the venting position, the pivoting lid may rotate about the hinge to be at least 65 degrees from the griddle surface. In the breakout position, the pivoting lid may rotate about the hinge to be at least 210 degrees from the griddle surface.

In some examples, a cooking apparatus may include a main body. The cooking apparatus may further include a substantially solid cooking surface coupled to the main body, the substantially solid cooking surface comprising a first layer, a second layer, and a third layer. The cooking apparatus may further include a lid coupled to the main body. The cooking apparatus may further include a lower cavity positioned below the substantially solid cooking surface and an upper cavity positioned above the substantially solid cooking surface when the lid is in a closed position, the main body being configured to sustain a temperature differential between the upper cavity and the lower cavity. The cooking apparatus may further include a heat distributor coupled to the third layer and extending into the lower cavity, the heat distributor configured to convert radiative heat into conductive heat.

In yet additional examples, this disclosure is directed to a contoured burner for a griddle cooking apparatus having a cooking pan with a curved end forming an arc. The burner may include a fuel inlet, an outer curved portion in fluid communication with the fuel inlet. The outer curved portion may be at least partially concentric with the arc at the curved end of the cooking pan. The burner may include a straight portion and a plurality of throat holes in the outer curved portion and the straight portion, the throat holes forming line at least partially concentric with the arc at the curved end of the cooking pan.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 is a perspective view of an example of a cooking system, according to some aspects of the present disclosure.

FIG. 2 is an exploded perspective view of an example of a cooking system, according to some aspects of the present disclosure.

FIG. 3 is a perspective view of an example of a main body of a cooking system, according to some aspects of the present disclosure.

FIG. 4 is a top perspective view of an example of a main body of a cooking system, according to some aspects of the present disclosure.

FIG. 5 is a cross-sectional perspective view of an example of a main body of a cooking system, according to some aspects of the present disclosure.

FIG. 6 is an internal perspective view of an example of a main body of a cooking system, according to some aspects of the present disclosure.

FIG. 7 is a perspective view of an example of a cooking surface, according to some aspects of the present disclosure.

FIG. 8 is a bottom perspective view of an example of a cooking surface, according to some aspects of the present disclosure.

FIG. 9A is a cross-sectional perspective view of an example of a cooking surface, according to some aspects of the present disclosure.

FIG. 9B is a detail view 9B of the example of a cooking surface in FIG. 9A, according to some aspects of the present disclosure.

FIG. 10 is a perspective view of an example of a stand of a cooking system, according to some aspects of the present disclosure.

FIG. 11 is a perspective view of an example of a stand of a cooking system, according to some aspects of the present disclosure.

FIG. 12 is a perspective view of an example of a main body of a cooking system, according to some aspects of the present disclosure.

FIG. 13 is an exploded perspective view of an example of a main body of a cooking system, according to some aspects of the present disclosure.

FIG. 14 is an exploded perspective view of an example of a grill, according to some aspects of the present disclosure.

FIG. 15 is a bottom perspective view of an example of a main body of a cooking system, according to some aspects of the present disclosure.

FIG. 16 is a perspective view of an example of a foot of a main body of a cooking system, according to some aspects of the present disclosure.

FIG. 17 is a top view of an example of a main body of a cooking system, according to some aspects of the present disclosure.

FIG. 18 is a front perspective view of an example of a cooking system, according to some aspects of the present disclosure.

FIG. 19 is a perspective view of an example of a main body of a cooking system, according to some aspects of the present disclosure.

FIG. 20 is a back perspective view of an example of a main body of a cooking system, according to some aspects of the present disclosure.

FIG. 21 is a side perspective view of an example of a hinge, according to some aspects of the present disclosure.

FIG. 22 is a perspective view of an example of a main body of a cooking system, according to some aspects of the present disclosure.

FIG. 23 is a block diagram of an example of an ignition system, according to some aspects of the present disclosure.

FIG. 24 is a perspective view of an example of a main body of a cooking system, according to some aspects of the present disclosure.

FIG. 25 is a perspective view of an example of a main body of a cooking system, according to some aspects of the present disclosure.

FIG. 26 is a cross-sectional perspective view of an example of a main body of a cooking system, according to some aspects of the present disclosure.

FIG. 27 is a perspective view of an example of a cooking surface, according to some aspects of the present disclosure.

FIG. 28 is a top view of an example of a burner dish, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Described herein are systems, devices, and methods for optimizing features of a multi-use cooking system. The cooking system may be optimized for interchangeability or simultaneous use of multiple different cooking surfaces including, for example, a griddle and a grill surface. The main body of the cooking system may be equipped for optimal useability and cooking properties both when used in conjunction with a stand and when used independently. The cooking system may further be equipped for multiple other features for increasing durability, cooking properties, and/or versatility. Thus, the present disclosure allows for a multi-use cooking system with improved features, thereby allowing for an overall improved cooking experience for the user and others.

In some implementations, the main body of the cooking system may be equipped with specialized airflow to optimize interchangeability between a griddle and grill surface. In general, griddles are designed to operate at much lower temperatures than grills. Thus, in some implementations of the cooking system, the internal airflow design allows for compatibility with multiple surface types. For example, in some implementations, the main body includes vents adjacent to the griddle surface allowing heated airflow into the cooking chamber which would otherwise be blocked by the solid griddle. Thus, the vents prevent overheating of the griddle by allowing release of the heated air in the burner housing beneath the griddle. In some implementations, when the grill surface is used in place of the griddle, the vents may become less important as air may travel freely through the grill itself.

For another example, the internal airflow of the main body of the cooking system may include bifurcated airflow channels. A first channel includes intake of airflow from the environment into vents in the burner housing and a second channel intakes airflow through the same vents and directs airflow into a cavity of the burner housing containing the burners. The first channel and the second channel may converge at the upper portion of this cavity at the vents opening into the cooking chamber. Thus, the first channel may provide relatively cooler air from the ambient environment while the second channel may provide heated air from the burners. This bifurcated airflow design may help prevent the griddle from overheating and may provide an optimal temperature gradient in the cooking chamber. In some implementations, the lid of the main body may include a concave lower surface which may direct airflow in the cooking chamber from the vents towards the center of the cooking chamber creating a more consistent temperature gradient.

In some implementations, airflow design is especially important as a griddle design with multiple laminate layers is desirable for increasing durability and ensuring even across the griddle surface. The airflow design allows for a griddle surface with increased layer without deoptimizing its cooking properties. Thus, in some implementations, the griddle may include a three-layer laminate structure including a surface layer of 304 stainless steel, a core layer of aluminum, and a bottom layer of 430 stainless steel. This three-layer laminate design may have increased durability and optimized heat distributive properties.

In some implementations, the griddle may be equipped with an additional structure at the bottom allowing for increased heat distribution across the griddle. For example, in some implementations, the griddle may include a series of angle-iron ridges which may provide additional surface area to the lower surface of the griddle for heat distribution while also structurally supporting the griddle by preventing warping due to long term heat exposure.

In some implementations, the griddle and other elements of the main body may include specialized curved contoured ends which may increase convective and radiative heat flow properties of the cooking system. In some implementations, the burners may also include a curved contour to allow for even fuel distribution across the throat holes, further optimizing heat distribution.

In some implementations, for example due to the cooking systems dual compatibility with both a griddle and grill surface, the main body may include a half-griddle and half-grill configuration which divides the cooking surface. Thus, both the half-griddle and half-grill may operate simultaneously while both surfaces may have optimized cooking properties. Thus, in some implementations, the cooking surface may be inset on a ledge in the burner housing to allow for easy and/or quick interchangeability between a full griddle surface, a full grill surface, and the half-griddle and half-grill surface(s).

In some implementations, the cooking system optimizes the compatibility of the main body and its stand by allowing the main body to operate at increased effectiveness in conjunction with the stand and in an independent, portable configuration. For example, in some implementations, the structure of the stand allows for the main body to firmly nest within stand while also being easily removable to quickly convert to the portable configuration. The stand may include lateral support structures for securing the sides of the main body and lower supports which provide a gap between the bottom of the main body and platform for heat dispersion.

In some implementations, the main body and stand may be equipped with a stabilizer system for ensuring the cooking surface is level when the main body is positioned on the stand. The main body may be positioned on four adjustable feet which may be independently adjustable to allow for adjustment of the height and angle of the cooking surface in three dimensions. These adjustable feet may also be used to level the cooking surface when the main body is used on uneven surfaces in the portable configuration.

In some implementations, the stand may further include an integral fuel-tank loader. The fuel-tank loader may allow the fuel tank to pivot out of the stand to allow the user easier access to the fuel tank and/or fuel line when loading a new fuel tank into the stand. In some implementations, the fuel-tank loader may also allow the user to easily disengage the fuel tank to shift the main body into the independent, portable configuration.

In some implementations, the main body may further include a two-stage hinge which may allow the lid of the main body to easily and quickly transition between a closed configuration, an open configuration, and an open layout in which the lid is pivoted up to 270 degrees with respect to the cooking surface. The two-stage hinge allows for the lid to pivot seamlessly between the at least three stages while also securely locking at each stage to prevent the lid from swinging freely. Thus, both in conjunction with the stand and in the portable configuration, the main body of the cooking system may be optimized for multiple types of uses.

In some implementations, the cooking system may include additional features which may, for example, increase the safety and/or cooking properties of the cooking system. For example, gas-fueled cooking systems typically include internal flavorizer bars which prevent substances such as grease and oil from penetrating the throat holes of the burner. In conventional grills, these flavorizer bars may be integral with the burners, as the grill is not designed to also operate with a griddle. Thus, in some implementations, the interchangeable grill or half-grill of the cooking system may be equipped with an integral flavorizer which may be suspended from the cooking grate. Thus, the user does not need to remember to remove the flavorizer when transitioning from the grill to the griddle or remember to insert the flavorizer when transitioning from the griddle to the grill. Thus, the cooking system may ensure that the burners and/or the user will always be protected regardless of the configuration.

In some implementations, the main body of the cooking system may include a dual-action control which may seamlessly release and ignite fuel within the burners with one fluid movement of the control. For example, the control knobs may be equipped to release fuel and actuate a piezo igniter simultaneously. In some implementations, the main body may also include one or more view holes which may allow the user to have visibility of the burners when the griddle is in use. In some implementations, the view holes may be specially designed to prevent flames or sparks from exiting through the view hole and injuring the user.

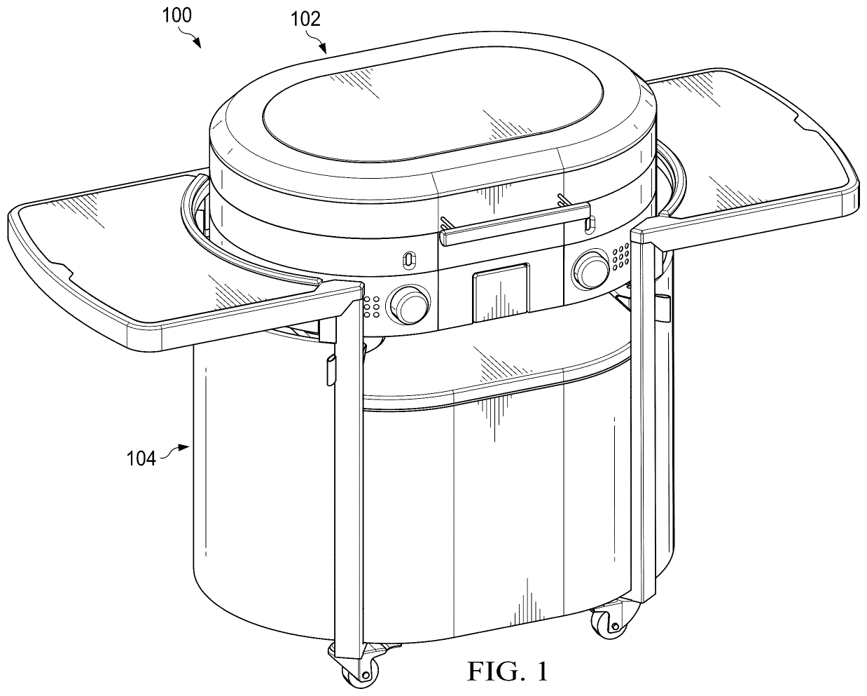

FIG. 1 is a perspective view of an example of a cooking system 100, according to some aspects of the present disclosure. The cooking system 100 may include at least a main body 102 and a stand 104. In some implementations, the main body 102 may also be referred to as a griddle, a cooking apparatus, a griddle cooking apparatus, and/or any other suitable term. In some implementations, the stand 104 may position the main body 102 a distance above the ground. For example, in some implementations, the main body 102 may be nested within the stand 104 such that at least a portion of the stand 104 secures the main body 102 substantially or fully in place. In some implementations, the main body 102 may be removable from the stand 104 such that the main body 102 may operate independently from the stand 104. In some implementations, as discussed further herein, the main body 102 and accompanying fuel line (not shown) and fuel tank (not shown) may be removable from the stand and the main body 102 may be portable and/or may be placed on a surface, such as a table.

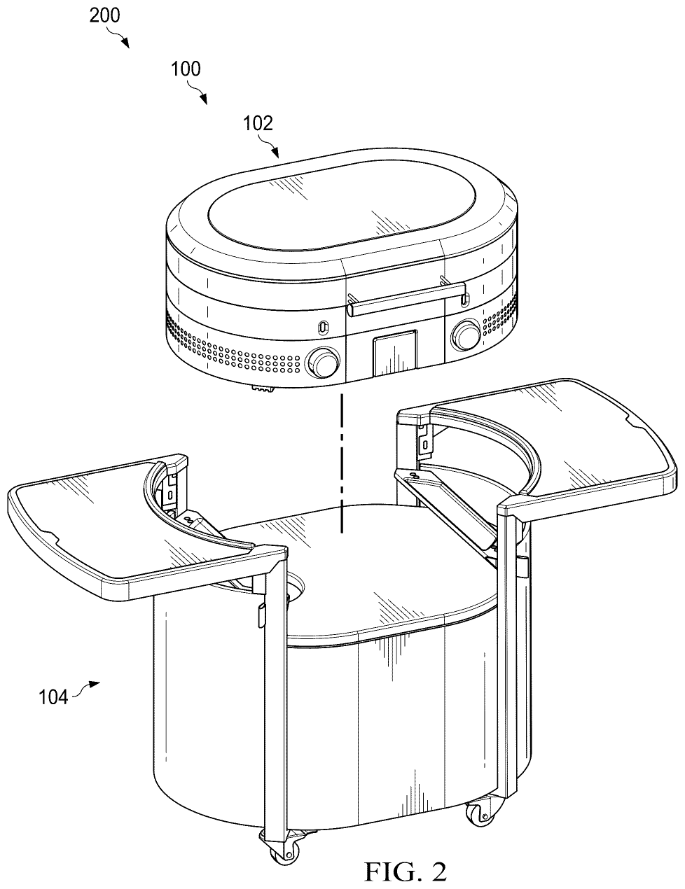

FIG. 2 is an exploded perspective view 200 of an example of a cooking system 100, according to some aspects of the present disclosure. The cooking system 100 may include at least a main body 102 and a stand 104.

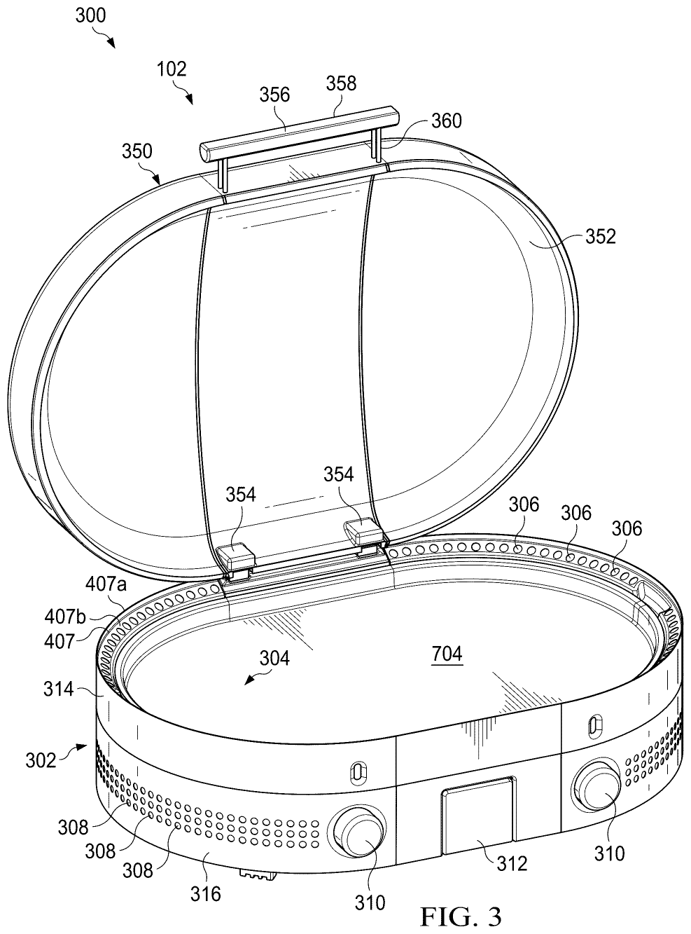

FIG. 3 is a perspective view 300 of an example of a main body 102 of a cooking system 100, according to some aspects of the present disclosure. As shown in the example in FIG. 3, in some implementations, the main body 102 may include a lid 350 which may pivot about one or more hinges 354. Thus, the main body 102 may transition from a closed position to an open position by pivoting the lid 350 upwardly about the hinges 354 and may transition from the open position to the closed position by pivoting the lid 350 downwardly about the hinges 354. In some implementations, the closed position may be defined by the lid being substantially or fully flush with at least a portion of a burner housing 302 of the main body 102. In some implementations, the open position may be defined by the lid 350 pivoting more than 45 degrees from the closed position. In some implementations, the open position may be defined by the lid 350 pivoting more than 90 degrees from the closed position.

In some implementations, the lid 350 may include a concave surface 352 and one or more handles 356. In some implementations, the lid 350 may include a handle 356 extending from the top and/or one or more sides of the lid 350. In some implementations, the handle 356 may be grabbed by a user to assist the user in transitioning the lid 350 between the closed position and the open position. In some implementations, the handle 356 may include a non-metal grip 358. The non-metal grip 358 may be a relatively low-conducting or non-conducting material relative to the rest of the main body 102. Depending on the implementation, the grip 358 may be made of any material or materials including, for example, plastic, rubber, ceramic, wood, and/or any other suitable material. In some implementations, the grip 358 may extend a distance away from the rest of the lid 350 by one or more rods 360 such that a user's hand may have space to grip the grip 358 without touching the rest of the lid. Depending on the implementation, the grip 358 may be positioned any distance away from the lid including, for example, two inches to four inches. In some implementations, the lid 350 may include more than one handle 356. In some implementations, the lid 350 may include a concave surface positioned at the bottom of the lid 350. The concave surface 352 may create a cavity bounded by at least the concave surface 352 and the cook pan 304 when the lid 350 is in the closed position. Depending on the implementation, the concave surface 352 may have a contour of any size or shape.

The main body 102 may further include a burner housing 302 and a cook pan 304. The burner housing may include at least some of all of one or more upper vent openings 306, one or more lower vent openings 308, one or more control knobs 310, and a grease trap 312. In some implementations, the burner housing 302 may include a plurality of upper vent openings 306 which may face at least partially upwardly. In some implementations, the plurality of upper vent openings 306 may be positioned in a ring around and/or adjacent to the cook pan 304. The plurality of upper vent openings 306 may open a lower cavity of the burner housing 302 to the upper cavity or the environment depending on if the lid 350 is in the closed position or the open position, respectively. It should be understood that the plurality of upper vent openings 306 may each face any direction depending on the embodiment including, for example, at least partially towards the center of the burner housing 302, at least partially to the outer sides of the burner housing 302, at least partially downwardly, and/or any other direction. It should be understood that, while the plurality of upper vent openings 306 have a circular shape in the example of FIG. 3, the plurality of upper vent openings 306 may be any shape and/or size including, for example, elliptical, triangular, square, rectangular, polygonal, a complex contour, or any other suitable shape.

In some implementations, the burner housing 302 may include a plurality of lower vent openings 308 which may face at least partially outwardly. In some implementations, the plurality of lower vent openings 308 may be positioned in one or more rows at least partially along the sides of the burner housing 302. It should be understood that the burner housing 302 may include any number of lower vent openings 308 which may be arrange in any pattern. In some implementations, the plurality of lower vent openings 308 may be positioned on the bottom of the burner housing 302 instead of or in addition to being positioned on the side of the burner housing 302. The plurality of lower vent openings 308 may open a lower cavity of the burner housing 302 to the environment. It should be understood that the plurality of lower vent openings 308 may each face any direction depending on the embodiment including, for example, at least partially towards the center of the burner housing 302, at least partially upwardly, at least partially downwardly, and/or any other direction. It should be understood that, while the plurality of lower vent openings 308 have a circular shape in the example of FIG. 3, the plurality of lower vent openings 308 may be any shape and/or size including, for example, elliptical, triangular, square, rectangular, polygonal, a complex contour, or any other suitable shape.

The burner housing may include a plurality of control knobs 310 positioned on the front and/or sides of the burner housing 302. As shown in the example of FIG. 3, the burner housing 302 include four control knobs 310 positioned on the front of the burner housing 302. However, it should be understood that, depending on the environment, the burner housing may include any number of control knobs 310 including, for example, two control knobs 310. In some implementations, two control knobs 310 may be positioned symmetrical to two other control knobs 310 about a vertical axis running through the center of the front of the burner housing 302. It should be understood that, depending on the implementation, the control knobs 310 may have any size, shape, length extending from the surface of the burner housing 302, and/or position on the burner housing 302. While control knobs 310 are shown in the example of FIG. 3, it should be understood that any actuator be used instead of the control knobs including, for example, one or more of a dial, a switch, a dimmer, and/or any other suitable actuator.

The burner housing may include a grease trap 312. As shown in the example of FIG. 3, in some implementations, the grease trap 312 may be positioned in the front center of the burner housing. However, it should be understood that, depending on the implementation, the grease trap 312 may be positioned at any position on the burner housing 302 including, for example, the back and/or the sides.

In some implementations, the burner housing may further include an upper burner housing 314 and a lower burner housing 316. Depending on the implementation, the upper burner housing 314 and the lower burner housing 316 may be made of the same material or different materials. Depending on the implementation, the upper burner housing 314 and the lower burner housing 316 may be the same color or different colors.

The main body 102 may include a cook pan 304. It should be understood that depending on the implementation the cook pan 304 may be referred to by other terms, including, for example, a griddle, a griddle surface, a cooking surface, a tray, a pan, a sheet, and/or any other suitable term. In some implementations, the cook pan 304 may be inset into the burner housing such that the upper surface of the cook pan 304 is positioned lower than the highest portion of the side of the burner housing 302. In some implementations, the burner housing 302 may include a slanted surface including the plurality of upper vent openings 306 that extend from the sides of the burner housing 302 downwardly to the cook pan 304. In some implementations, the cook pan 304 may be concave such that the upper surface of the cook pan 304 is positioned below the edges of the cook pan 304.

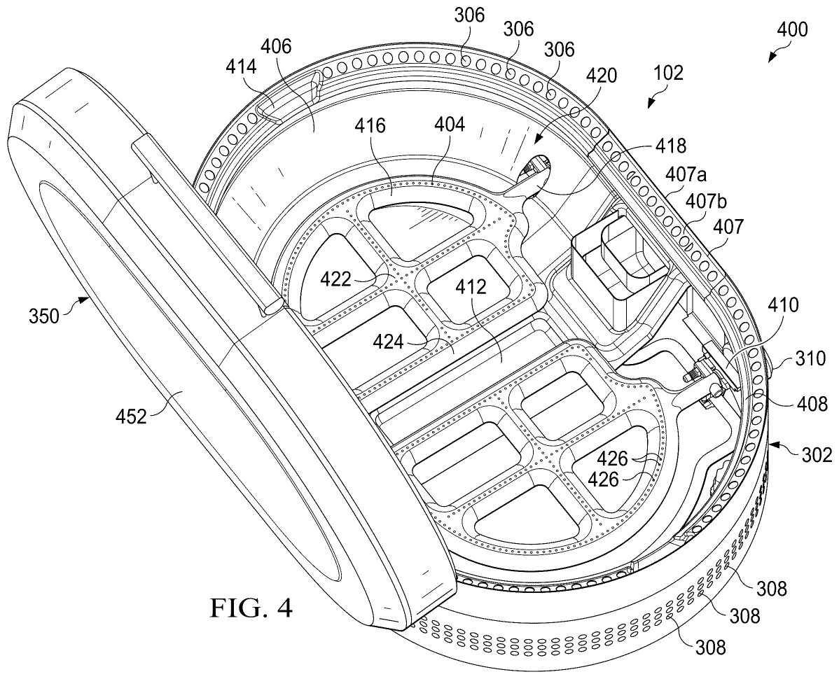

FIG. 4 is a top perspective view 400 of an example of a main body 102 of a cooking system 100, according to some aspects of the present disclosure. In the example shown in FIG. 4, the cook pan 304 is removed to show a top view of the lower cavity of the burner housing 302. The burner housing may further include at least some or all of one or more burners 404, a burner dish 406, a rim, 407, a ledge 408, a piezo igniter 410, and a grease pan 412.

As shown in the example of FIG. 4, the burner housing 302 may include two burners positioned within the lower cavity. It should be understood that depending on the implementation, the burner housing may include any number of burners including, for example, four burners. The burners 404 may operate with any type of fuel including for example, propane, butane, kerosene, and/or any other suitable gas fuel. The burners 404 may receive the fuel from the from a fuel channel 418 or fuel inlet extending from a valve adjacent to the one or more piezo igniters 410. In some implementations, actuating the control knobs 310 or other actuator may cause the valve adjacent to the piezo igniter 410 to release fuel into the fuel channel 418 and the control knobs 310 or other actuator may cause the piezo igniter 410 to create a spark and ignite the fuel in the fuel channel 418. The fuel may flow into other parts of the burners 404. The burners may further include an outer curved portion 416 which may at least partially correspond to the curved structure of the burner housing 302. The curved contour of the main body 102, burner housing 302, cook pan 304, plurality of upper vent openings 306, and/or burners 404 may increase the convective and or radiative heat distribution properties of the cooking system 100. The burners 404 may also include a cross-shaped portion 422 positioned substantially in the center of the burner. The burners 404 may include a straight portion 424 positioned opposite the curved portion 416 causing the burner to have a substantially or fully semi-circular or semi-elliptical shape. The burners 404 may include four gaps adjacent to the cross-shaped portion 422 causing the cross-shaped portion 422 to have a cross shape. In some implementations, the four gaps in the burners 404 may have at least one corner or edge with a fillet and/or chamfer. The burners 404 may include a plurality of throat holes 426 opening at least partially upwardly and/or positioned on the upper surface of the burners 404. Thus, fuel may flow from the valve adjacent to the piezo igniter 410, along the fuel channel 418, into the burners 404, and out the throat holes 426 creating a flame at the throat holes 426. It should be understood that depending on the implementation, the throat holes 426 may have any size and/or shape and the throat holes 426 may have different sizes. For example, in some implementations, the size of the throat holes 426 may increase or decrease as the distance of the throat hole 426 from the fuel valve increases. In the example shown in FIG. 4, the throat holes 426 are aligned and positioned in a row extending along the curved portion 416, the cross-shaped portion 422, and the straight portion 424. However, it should be understood that depending on the implementation, the throat holes 426 may be positioned on any part of the burners 404. The burners 404 may be actuated by the control knobs 310 or any other type of actuator. It should be understood that the burners 404 may be any size and/or shape including, for example, shaped to be circular, elliptical, ring-shaped, triangular, rectangular, polygonal, u-shaped, x-shaped, cross-shaped, semi-circular, semi-elliptical, parabolic, and/or any other suitable shape.

The burner dish 406 may be positioned adjacent to the burners 404 and may at least partially bound the lower cavity of the burner housing 302. In some implementations, the burner dish may extend from the grease pan 412 to the ledge 408. However, in some implementations one or more gaps may extend between the grease pan 412 and the burner dish 406 and between the ledge 408 and the burner dish 406 allowing air from the plurality of lower vent openings to flow into the lower cavity or allowing air from the lower cavity to flow out of the plurality of upper vent openings. In some implementations, the burner dish 406 may have an inwardly facing surface that may be at least partially slanted at any angle including for example, 30 degrees, 45 degrees, 60 degrees, 75 degrees, and/or any other angle. In some implementations, the burner dish 406 may have one or more openings allowing the fuel channels 418 and/or grease trap 312 to extend into the lower cavity.

In some implementations, a rim 407 may be positioned at the top of the burner housing 302 adjacent to the outer edge of the burner housing 302. In some aspects, the rim 407 may further include a ridge 407a and a step 407b. In some implementations, the ridge 407a may be positioned at the top of the burner housing 302 adjacent to the outer edge of the burner housing 302 and the step 407b may be positioned inwardly and/or lower than the ridge 407a. The plurality of upper vent openings 306 may be positioned on the step 407b and/or the rim 407. In some aspects, the rim 407 may extend continuously from the outer edge of the burner housing to the ledge 408. In some aspects, the ledge 408 may positioned adjacent to the step 407b and/or the rim 407. In some aspects, the ledge 408 may project from the step 407b and/or the rim 407. In some aspects, the cook pan 304 may be disposed on the ledge 408 in a manner that the cook pan 304 rests on and/or is supported by the ledge 408 and is positioned adjacent to the step 407b and/or the rim 407. In some aspects, the cook pan 304 may be supported by the ledge 408 in a manner that a portion of the cook pan 304 extends from one entirely or substantially straight portion of the ledge 408 to another entirely or substantially straight portion of the ledge 408 supporting the cook pan 304 on the burner housing 302.

In some implementations, the ledge 408 may be positioned between the burner dish 406 and the plurality of upper vent openings 306. In some implementations, the ledge 408 may be positioned to extend at least partially from the sides of the burner housing 302 into the lower cavity such that the cook pan 304 may rest on the ledge. In some implementations, the burner housing 302 may have one or more indentations 414 which may allow the user to pivot the cook pan 304 from the ledge 408 and from being inset into the burner housing 302.

The grease pan 412 may be positioned at the bottom of the lower cavity. Thus, the burner dish 406 may funnel into the grease pan 412. Thus, grease, embers, charred matter, and/or food scraps may be directed by the burner dish 406 into the grease pan 412.

The lid 350 may further include a top surface 452 which may be positioned opposite the concave surface 352.

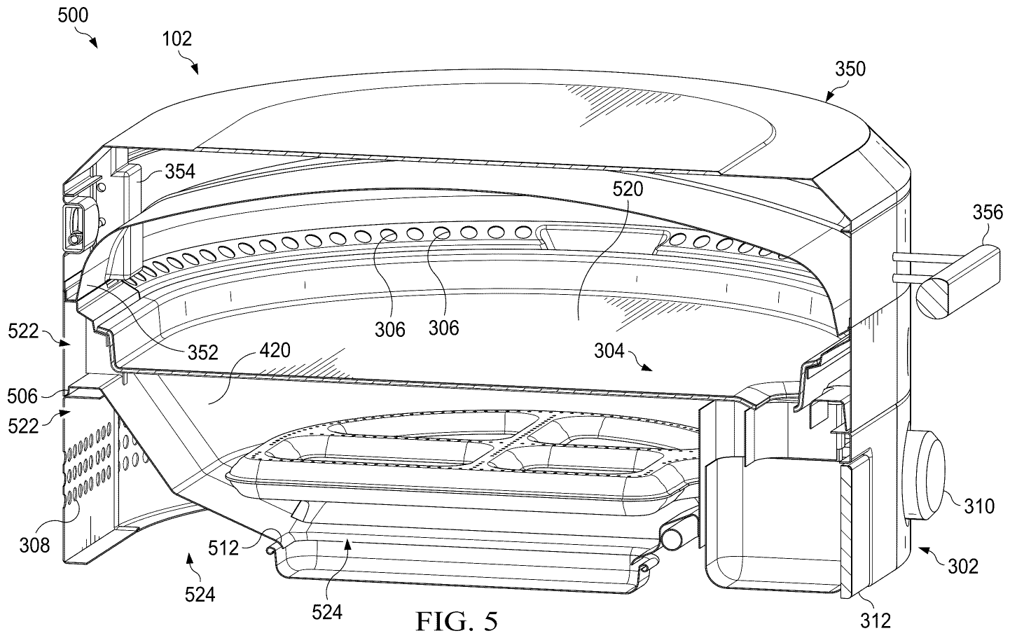

FIG. 5 is a cross-sectional perspective view 500 of an example of a main body 102 of a cooking system 100, according to some aspects of the present disclosure. FIG. 5 may further illustrate the movement of airflow within the burner housing 302 and upper cavity 520. The upper cavity 520 may be formed when the lid 350 is in the closed position. Thus, the upper cavity 520 may be positioned between the cook pan 304 and the concave surface 352 of the lid 350.

In some implementations, air may flow from the plurality of lower vent openings 308 to the upper cavity 520. In some implementations, air may flow in a first channel 522 extending from the plurality of vent openings 308 into the burner housing 302, through the first gap 506, into the lower cavity 420, through the plurality of vent openings 306, and/or into the upper cavity 520. In some implementations, air may flow in a second channel 524 extending from the plurality of vent openings 308 into the burner housing 302, through the second gap 512, into the lower cavity 420, through the plurality of vent openings 306, and/or into the upper cavity 520. Thus, in some implementations the second channel 524 may converge with the first channel 522 in the lower cavity 420. Thus, in some implementations, both relatively cool air from the first channel 522 and heated air from the second channel 524 may flow into the upper cavity 520.

In some implementations, the burner dish 406 may extend to be substantially flush with the side of the burner housing 302. In some implementations, a first gap 506 may be positioned between the burner dish 406 and the burner housing 302. Thus, the first gap 506 may allow for air to flow in the first channel 522 from the plurality of lower vent openings 308 into the lower cavity.

In some implementations, the burner dish 406 may extend to be substantially flush with the grease pan 412. In some implementations, a second gap 512 may be positioned between the burner dish 406 and the grease pan 412. Thus, the second gap 512 may allow for air to flow in the second channel 524 from the plurality of lower vent openings 308 into the lower cavity.

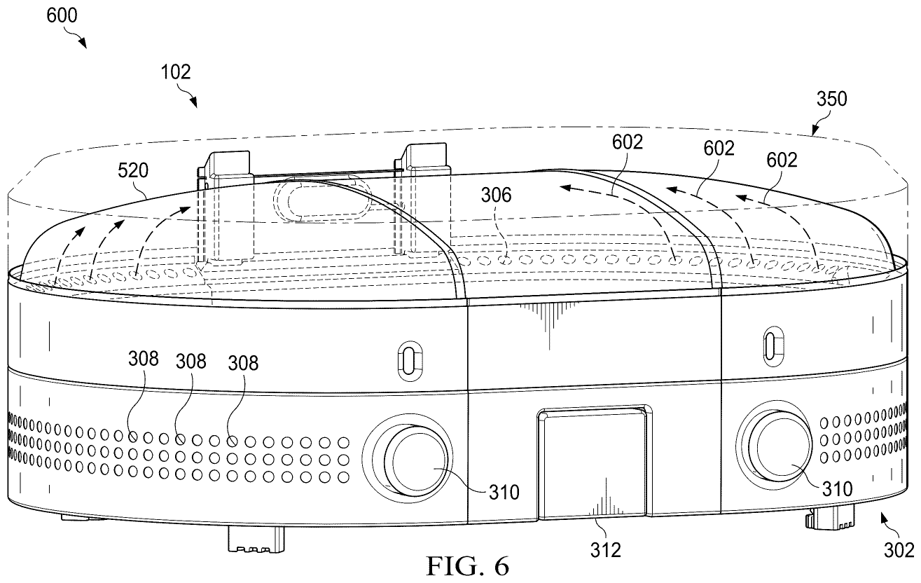

FIG. 6 is an internal perspective view 600 of an example of a main body 102 of a cooking system 100, according to some aspects of the present disclosure. Thus, FIG. 6 may further illustrate the lid 350 of the main body 102 in the closed position. In some implementations, when the lid 350 is in the closed position, the concave surface 352 may form a dome shaped upper cavity 520 above the cook pan 304. Heated air from the burner housing 302 may flow through the plurality of upper vent openings 306 as shown by directional arrows 602. When the heated air flow through the plurality of upper vent openings 306, the concave and/or domed shape of the concave surface 352 may cause the directional arrows 602 symbolizing the flow of the heated air to curve inwardly towards the center of the cook pan 304. Thus, the concave surface 352 may help distribute heated air from the burner housing 302 throughout the upper cavity 520. Furthermore, in some implementations, the concave and/or domed structure of the concave surface 352 may distribute conductive, convective, and/or radiative heat more effectively than a rectangular surface. The example of FIG. 6 also illustrates that the plurality of upper vent openings 306 allow heated air to flow into the upper cavity 520 that would otherwise be prevented by the substantially solid cook pan 304.

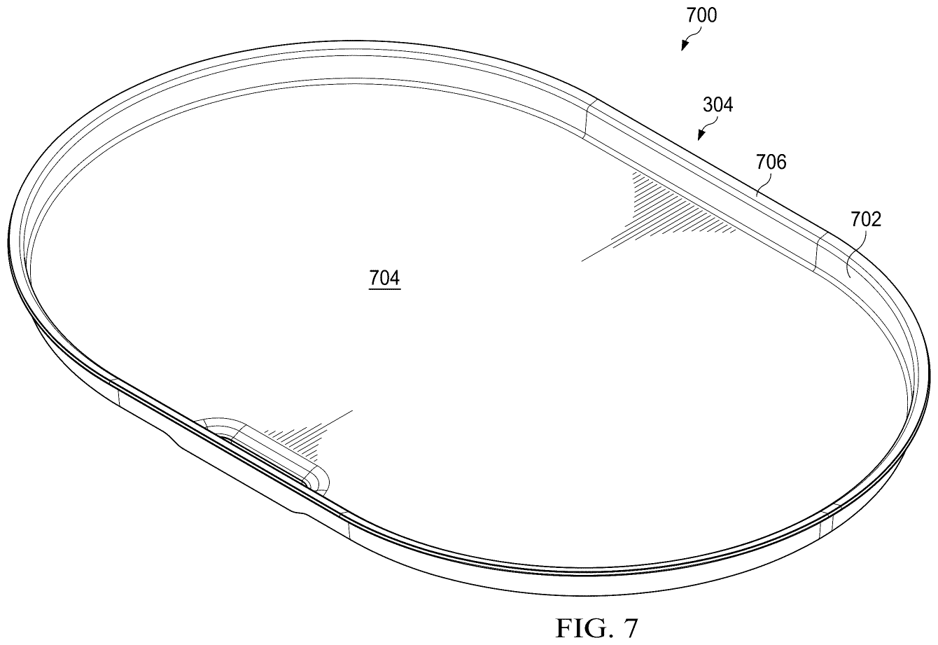

FIG. 7 is a perspective view 700 of an example of a cooking surface 304, according to some aspects of the present disclosure. In some implementations, the cook pan 304 may include cook pan wall 702, a cook pan surface 704, and a lip 706. The cook pan surface 704 may be positioned in the center of the cook pan 304 and may be substantially or fully flat. In some implementations, the cook pan 304 may only include a cook pan surface 704 and may be substantially or fully flat.

The cook pan wall 702 may extend around the cook pan surface 704. Thus, the cook pan wall 702 may form the cook pan 304 into a shallow pan. It should be understood that the cook pan wall 702 may be any shape or height including, for example, a height of one inch to four inches. In some implementations, the cook pan 304 may be manufactured by deep drawing one or more plates of material, including, for example, a plate of steel and/or aluminum. Thus, each of the one or more layers of the cook pan 304 may, in some implementations, be formed of a solid piece of material. It should be understood that each layer of the cook pan 304 may be made of any material or materials, including, for example, metal, alloy, steel, aluminum, iron, graphite, stainless steel, 304 stainless steel, 430 stainless steel, 316 stainless steel, and/or any other suitable material. The lip 706 may be positioned on the upper edge of the cook pan wall 702 and extend outwardly.

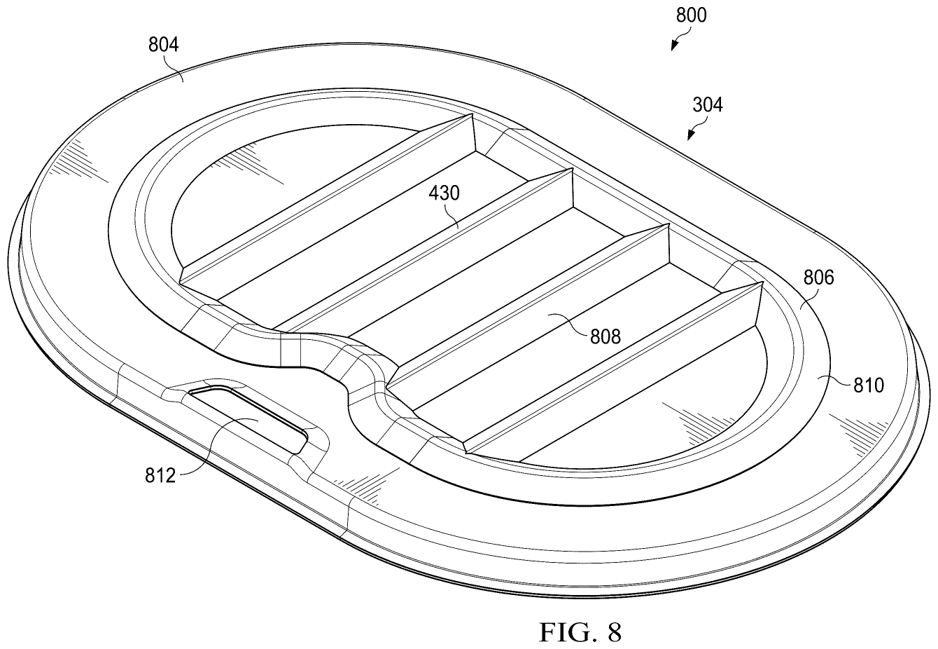

FIG. 8 is a bottom perspective view 800 of an example of a cooking surface 304, according to some aspects of the present disclosure. The example shown in FIG. 8 further illustrates the cook pan 304 from a bottom view 800. The cook pan 304 may further include a conduction surface 804, a ridged layer 806, and a grease drain 812. The conduction surface 804 may be positioned on the bottom of the cook pan 304. In some implementations, the conduction surface 804 may form the lower portion of the bottom layer of the cook pan 304. In some implementations, the ridged layer 806 may transfer heat from the burners to the conduction surface 804.

The ridged layer 806 may be positioned at the bottom of the cook pan 304 below the conduction surface 804. Depending on the implementation, the ridged layer 806 may have any size or shape including, for example, having a plurality of angle iron ridges 808, a plurality of angle iron ridges 808 with holes, a single fin, a plate, a distributive-heat plate, corresponding to the shape of the burners, and/or any other suitable shape. In some implementations, such as the example shown in FIG. 8, the ridged layer 806 may have a plurality of angle-iron ridges 808 extending substantially or fully parallel to the widthwise axis of the cook pan 304. In some implementations, the ridged layer 806 may have a plurality of angle-iron ridges 808 extending substantially or fully parallel to the lengthwise axis of the cook pan 304. In some implementations, the ridged layer 806 may further include a ring 810 extending around the outer circumference of the ridged layer 806 and being positioned at one or both of the ends of the angle-iron ridges 808. Depending on the implementation, the ring 810 of the ridged layer 806 may be any size or shape including, for example, circular, elliptical, rectangular, polygonal, a complex shape, and/or any other suitable shape. It should be understood that in some implementations the plurality of angle-iron ridges 808 may instead have difference structure including, for example, being shaped as rods, fins, bars with a rectangular or square cross section, plates, and/or any other suitable shape. In implementations in which the ridged layer 806 includes a plurality of angle-iron ridges 808 with one or more holes, the holes may be any size and/or shape and/or may be positioned at any location on the angle-iron ridges 808. In some implementations, instead of a plurality of angle-iron ridges 808, the ridged layer 806 may include a single fin extending lengthwise along the conduction surface 804 or extending widthwise along the conductive surface. In some implementations, instead of or in addition to a ridged layer 806, the cook pan 304 may include a plate coupled to the conduction surface. Thus, the plate may be a material effective at absorbing radiated heat and converting the heat to conductive heat including, for example, metal, alloy, steel, aluminum, iron, graphite, stainless steel, 304 stainless steel, 430 stainless steel, 316 stainless steel, and/or any other suitable material. In some implementations, instead of or in addition to the ridged layer 806, the cook pan 304 may include a distributive-heat plate. The distributive-heat surface may have a structure with high surface area positioned on the bottom surface of the plate configured to absorb radiative heat from the burners and convert it to conductive heat. The distributive-heat plate may have any size and/or shape including, for example, angle-iron ridges, ridges, fins, rods, rectangular bars, cylindrical cross sections, and/or any other suitable shape.

In some implementations, instead of or in addition to the ridged layer 806, the cook pan 304 may include a layer with a shape substantially or fully corresponding to the shape of the burners 404. For example, in implementations associated with the example shown in FIG. 4, the layer may have a shape corresponding to the shape of burners 404, including, for example, a curved portion 416, a straight portion 424, a cross-shaped portion 422, the alignment of the throat holes 426, and/or any other suitable shape. It should be understood, however, that the layer may correspond to the shape of any type of burner, including, for example, shaped to be circular, elliptical, ring-shaped, triangular, rectangular, polygonal, u-shaped, x-shaped, cross-shaped, semi-circular, semi-elliptical, parabolic, and/or any other suitable shape. In some implementations, the ridged layer 806 may have angle-iron ridges 808 and/or a ring 810 corresponding to the shape of the burners. For example, in some implementations, the angle-iron ridges 808 may vary in length or width to substantially or fully correspond to the outer circumference and/or throat holes 426 of the burners 404. For another example, in some implementations, the ring 810 of the ridged layer 806 may have a circumference to substantially or fully correspond to the outer circumference of the burners. It should be understood, however, that the ridged layer 806 (including, for example, the angle-iron ridges 808 and/or the ring 810 of the ridged layer 806) may correspond to the shape of any type of burner, including, for example, shaped to be circular, elliptical, ring-shaped, triangular, rectangular, polygonal, u-shaped, x-shaped, cross-shaped, semi-circular, semi-elliptical, parabolic, hyperbolic, and/or any other suitable shape. It should be understood that the ridged layer 806 and/or any substitutes described herein may be made of any material or materials including, for example, metal, alloy, steel, aluminum, iron, graphite, stainless steel, 304 stainless steel, 430 stainless steel, 316 stainless steel, and/or any other suitable material. In some implementations, the ridged layer 806 and/or any substitutes described herein may be made of a material or materials with relatively low heat transfer properties, including, for example, carbon steel, cast iron, and/or any other suitable material. It should be understood that depending on the implementation, the ridged layer 806 and/or any substitutes described herein may be configured to provide support to the cook pan 304 and/or may be configured to assist in distributing heat to the cook pan 304. It should be understood that depending on the implementation, the ridged layer 806 or any substitutes described herein may be coupled to the rest of the cook pan 304 by any manufacturing method including, for example, welding, brackets, rivets, brazing, fasteners, and/or any other suitable attachment mechanism.

The grease drain 812 may be positioned on the cook pan surface 704 and may be configured to receive grease, oil, charred matter, food scraps, and/or other debris from the cook pan surface 704. The grease drain 812 may be positioned above the grease trap 312 such that grease, oil, and other debris may drop into the grease trap 312. The grease drain 812 may be positioned at any position on the cook pan surface 704 including, for example, anywhere on the outer perimeter of the cook pan surface 704, the center, near the outer perimeter of the cook pan surface 704, and/or any other position. In some implementations, the cook pan 304 may include a plurality of grease drains 812 located at any position. In some implementations, the cook pan surface 704 may be sloped and/or may slope towards the grease drain 812.

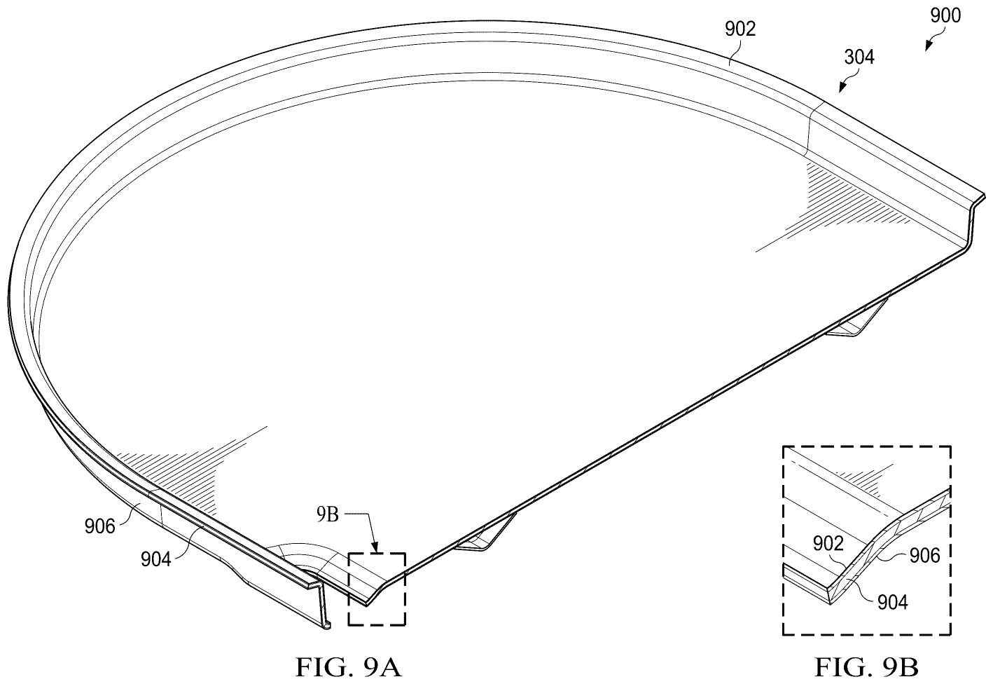

FIG. 9A is a cross-sectional perspective view 900 of an example of a cooking surface 304, according to some aspects of the present disclosure. In some implementations such as the example shown in FIG. 9A, the cook pan 304 may further comprise an upper layer 902, a central layer 904, and a lower layer 906. However, it should be understood that depending on the implementation, the cook pan 304 may have any number of layers. The upper layer 902, the central layer 904, and the lower layer 906 may each have a cook pan surface, a cook pan wall, a lip, grease drain, and/or a conduction surface, and/or any other related features discussed with respect to FIGS. 7-8. In some implementations, the upper layer 902, the central layer 904, and the lower layer 906 may be formed by deep drawing three substantially or fully flat plates such that the plates couple together, for example, in shallow pans. Thus, in some implementations, the cook pan wall 702 and lip 706 may cause the layers of the cook pan 304 to bond together. In some implementations, the cook pan 304 may be said to be a laminate surface which may include multiple laminate layers. It should be understood that each of the upper layer 902, the central layer 904, and the lower layer 906 may be coupled to the adjacent layer by any mechanism including, for example, cladding, welding, brackets, rivets, brazing, fasteners, and/or any other suitable attachment mechanism. In some implementations, a coating of any type may be applied between layers.

It should be understood that each of the upper layer 902, the central layer 904, and the lower layer 906 may be made of any material or materials including, for example, metal, alloy, steel, aluminum, iron, graphite, stainless steel, carbon steel, cast iron, 304 stainless steel, 430 stainless steel, 316 stainless steel, and/or any other suitable material. In some implementations, the upper layer 902 may be steel, the central layer 904 may be aluminum, and the lower layer 906 may be steel. In some implementations, the upper layer 902 may be stainless steel, the central layer 904 may be aluminum, and the lower layer 906 may be stainless steel. In some implementations, the upper layer 902 may be 304 stainless steel, the central layer 904 may be aluminum, and the lower layer 906 may be 430 stainless steel. In some implementations, some or all of the upper layer 902, the central layer 904, and the lower layer 906 may be coated with a finish including, for example, anodizing, blasting, buffing, polishing, electroplating, applying a coat of a material, and/or any other suitable finish. In some implementations, some or all of the upper layer 902, the central layer 904, and the lower layer 906 may be dyed with any color or colors including, for example, black, silver, grey, gold, bronze, brown, white, and/or any other color. In some implementations, the upper layer 902 may be made of a thicker gauge laminate than the rest of the layers which may allow for increased heat distribution throughout the cook pan surface 704.

FIG. 9B is a detail view 9B of the example of a cooking surface with three layers shown in FIG. 9A, according to some aspects of the present disclosure.

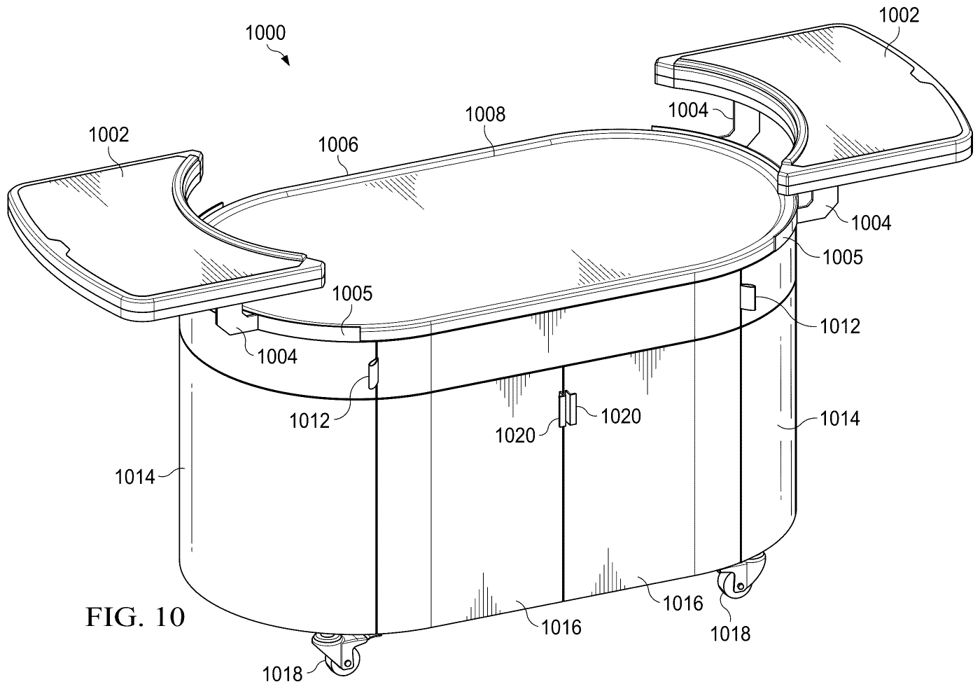

FIG. 10 is a perspective view 1000 of an example of a stand 1000 of a cooking system 100, according to some aspects of the present disclosure. The stand 1000 may include at least some or all of one or more shelves 1002, one or more bars 1004, one or more brackets 1005, an upper platform 1006, a curved ridge 1008, a front plate 1010, one or more side handles 1012, one or more side doors 1014, one or more front doors 1016, one or more wheels 1018, and/or one or more front handles 1020.

In some implementations, the stand 1000 may include two shelves 1002. The shelves 1002 may be positioned a distance above the platform 1006. The shelves 1002 may include a substantially or fully flat upper surface. In some implementations, the shelves 1002 may have an inner side contoured substantially or fully to correspond to at least a portion of the outer edge of the main body 102. In some implementations, the shelves 1002 may have one or more indentations and/or handles such that a user may grab a shelf 1002 or the stand 1000. In some implementations, the shelves may pivot about a hinge (not shown) positioned at the upper portion of the bars 1004. Thus, the shelves 1002 may pivot between a use condition as shown in the example of FIG. 10 in which the upper surface of the shelves 1002 is substantially or fully parallel to the platform 1006 and a stow condition in which the upper surface of the shelves 1002 pivots downwardly to be substantially or fully perpendicular to the platform or at least angled downwardly from the use condition. In some implementations, the hinges connecting the shelves 1002 and the bars 1004 may lock when the shelves are in the use condition such that the shelves 1002 do not collapse when an object is placed on an upper surface of the shelves 1002. In some implementations, the hinges connecting the shelves 1002 and the bars 1004 may lock when the shelves are in the stow condition such that the shelves 1002 do not wobble in the stow condition.

In some implementations, the stand 1000 may include four bars 1004 which may extend from the platform 1006. In some implementations, the bars 1004 may extend from a side of the stand for a distance and then extend upwardly such the bars 1004 each form a substantially or fully right angle. In some implementations, the bars 1004 may be aligned such that the curved sides of the main body 102 main be held securely on the platform 1006. For example, in some implementations, the bars 1004 on each side of the stand 1000 may be positioned in an arch substantially or fully corresponding the side of the main body 102. In some implementations, when the main body 102 is secured on the stand 1000 the bars 1004 may be manufactured such that the bars 1004 may be positioned a sufficient tolerance away from the main body 102 such that the fit between main body 102 and the stand 1000 may be a clearance fit including, for example, a loose running fit, a free running fit, a close running fit, a sliding fit, location fit, and/or any other type of fit.

The platform 1006 of the stand 1000 may be positioned above the front plate 1010 and/or below the shelves 1002. The surface of the platform 1006 may be substantially or fully flat. Depending on the implementation, the outer perimeter of the platform 1006 may be any size or shape. For example, in some implementations, the outer perimeter of the platform 1006 may be sized and shaped to substantially or fully correspond to the contour of the main body 102. In some implementations, the outer perimeter of the platform 1006 may be sized and shaped to be allow for a distance (e.g., ½ inches to 4 inches) to extend between the outer perimeter and the contour of the main body 102. In some implementations, the stand 1000 may have a chassis or frame which may provide support to the platform 1006 such that it may securely support the main body 102. In some implementations, the platform may have one or more fuel-line access holes (not shown) which may be positioned above a switch connecting the fuel tank (not shown) to the fuel line (not shown) such that the switch may be accessible to a user.

In some implementations, the stand 1000 may include a curved ridge 1008 which may be positioned around the circumference of the platform 1006. In some implementations, the main body 102 and the curved ridge 1008 may be sized and shaped such that the main body 102 fits substantially, fully, or partially within the inner circumference of the curved ridge 1008. In some implementations, the curved ridge 1008 may include a groove for each of the main body's 102 feet to be positioned in as discussed further herein.

In some implementations, the stand may include two brackets 1005. The brackets 1005 may be positioned on the ends of the platform 1006 extending farthest from the widthwise axis of the platform 1006 and may extend at least partially along and/or outside the outer circumference of the platform 1006 and/or the curved ridge 1008. In some implementations, the brackets 1005 may be sized and shaped to substantially or partially correspond with at least a portion of the main body's outer contour such that the main body 102 may be held securely on the platform 1006. In some implementations, when the main body 102 is secured on the stand 1000 the brackets 1005 may be manufactured and/or positioned such that the brackets 1005 may be positioned a sufficient tolerance away from the main body 102 such that the fit between main body 102 and the stand 1000 may be a clearance fit including, for example, a loose running fit, a free running fit, a close running fit, a sliding fit, location fit, and/or any other type of fit.

The front plate 1010 may be positioned at the front of the stand 1000 below the platform 1006. Depending on the implementation, the front plate 1010 may be positioned directly below or a distance below the platform 1006. In some implementations, the front plate 1010 may extend between the side doors 1014 and/or the far edges of the front doors 1016. In some implementations, one or more logos may be printed on the front plate 1010.

In some implementations, the stand 1000 may include two side doors 1014 which may be positioned at either end of the stand 1000. Thus, in some implementations, the side doors 1014 may be curved to substantially, fully, or partially corresponded to the curved portion of the platform 1006. However, it should be understood that, depending on the implementation, the side doors 1014 may be any size and/or shape. In some implementations, the side doors 1014 may pivot about a hinge positioned at the back of the stand 1000 providing an opening to an inner cavity of the stand 1000. In some implementations, one or more side handles 1012 may be positioned on the side doors 1014 which may allow a user to grab and open the side door 1014. In some implementations, such as the examples shown in FIG. 10, the side handles 1012 may be positioned substantially or fully at the upper front corner of the side door 1014; however, it should be understood that each side handle 1012 may be positioned anywhere on the side door 1014.

In some implementations, the stand 1000 may include two front doors 1016 which may be positioned at the front side of the stand 1000. Thus, in some implementations, the front doors 1016 may be substantially, fully, or partially flat. It should be understood that, depending on the implementation, the front doors 1016 may be any size and/or shape. In some implementations, front doors 1016 may pivot about a hinge positioned at the outer edge of the front doors 1016 providing an opening to an inner cavity of the stand 1000. In some implementations, one or more front handles 1020 may be positioned on the front doors 1016 which may allow a user to grab and open the front doors 1016. In some implementations, such as the examples shown in FIG. 10, the front handles 1020 may be positioned substantially or fully at the upper front corner of the front doors 1016; however, it should be understood that each front handle 1020 may be positioned anywhere on the front doors 1016.

In some implementations, the stand 1000 may include four wheels 1018. Thus, the stand 1000 may be moved by rolling the stand 1000 on the wheels 1018 across a floor.

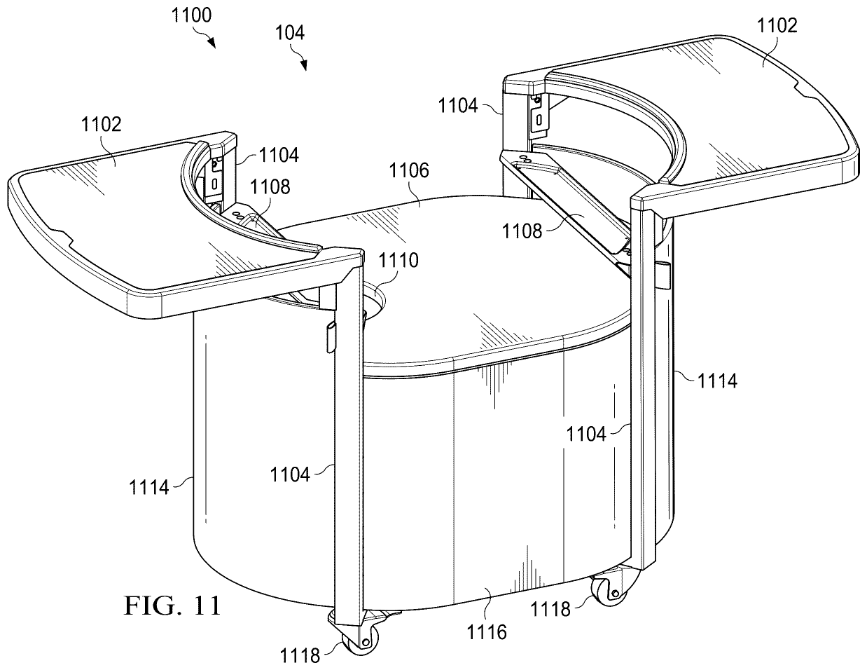

FIG. 11 is a perspective view 1100 of an example of a stand 104 of a cooking system 100, according to some aspects of the present disclosure. The stand 104 may include at least some or all of one or more shelves 1102, one or more bars 1104, an upper platform 1106, one or more beams 1108, one or more side panels 1114, one or more front panels 1116, and/or one or more wheels 1118.

In some implementations, the stand 104 may include two shelves 1102. The shelves 1102 may be positioned a distance above the platform 1106. The shelves 1102 may include a substantially or fully flat upper surface. In some implementations, the shelves 1102 may have an inner side contoured substantially or fully to correspond to at least a portion of the outer edge of the main body 102. In some implementations, the shelves 1102 may have one or more indentations and/or handles such that a user may grab a shelf 1102 or the stand 104. In some implementations, the shelves may pivot about a hinge (not shown) positioned at the upper portion of the bars 1104. Thus, the shelves 1102 may pivot between a use condition as shown in the example of FIG. 11 in which the upper surface of the shelves 1102 is substantially or fully parallel to the platform 1106 and a stow condition in which the upper surface of the shelves 1102 pivots downwardly to be substantially or fully perpendicular to the platform or at least angled downwardly from the use condition. In some implementations, the hinges connecting the shelves 1102 and the bars 1104 may lock when the shelves are in the use condition such that the shelves 1102 do not collapse when an object is placed on an upper surface of the shelves 1102. In some implementations, the hinges connecting the shelves 1102 and the bars 1104 may lock when the shelves are in the stow condition such that the shelves 1102 do not wobble in the stow condition.

In some implementations, the stand 104 may include four bars 1104 which may extend from the platform 1106, may extend from the lower edge of the front panel 1116, and/or may have any length depending on the implementation. In some implementations, the bars 1104 may extend from a side of the stand for a distance and then extend upwardly such the bars 1104 each form a substantially or fully right angle. In some implementations, the bars 1104 may couple to a side of the platform 1106 and extend upwardly to the bottom of the shelves 1102. In some implementations, the bars 1104 may be aligned such that the curved sides of the main body 102 main be held securely on the platform 1106. For example, in some implementations, the bars 1104 on each side of the stand 104 may be positioned in an arch substantially or fully corresponding the side of the main body 102. In some implementations, when the main body 102 is secured on the stand 104 the bars 1104 may be manufactured such that the bars 1104 may be positioned a sufficient tolerance away from the main body 102 such that the fit between main body 102 and the stand 104 may be a clearance fit including, for example, a loose running fit, a free running fit, a close running fit, a sliding fit, location fit, and/or any other type of fit.

The platform 1106 of the stand 104 may be positioned above the front panel 1116 and/or below the shelves 1102. The surface of the platform 1106 may be substantially or fully flat. Depending on the implementation, the outer perimeter of the platform 1106 may be any size or shape. For example, in some implementations, the outer perimeter of the platform 1106 may be sized and shaped to substantially or fully correspond to the contour of the main body 102. In some implementations, the outer perimeter of the platform 1106 may be sized and shaped to be allow for a distance (e.g., ½ inches to 4 inches) to extend between the outer perimeter and the contour of the main body 102. In some implementations, the stand 104 may have a chassis or frame which may provide support to the platform 1106 such that it may securely support the main body 102. In some implementations, the platform may have one or more fuel-line access holes 1110 which may be positioned above a switch connecting the fuel tank (not shown) to the fuel line (not shown) such that the switch may be accessible to a user.

In some implementations, the stand 104 may include two beams 1108 which may extend between two bars 1104. The beams 1108 may be positioned a distance above the platform 1106. The main body may rest on the beams 1108 such that the feet of the main body rest on the beams 1108 as discussed further herein. In some implementations, the beams 1108 may include a groove for each of the main body's 102 feet to be positioned in as discussed further herein.

In some implementations, the stand 104 may include two side panels 1114 which may be positioned at either end of the stand 104. Thus, in some implementations, the side panels 1114 may be curved to substantially, fully, or partially corresponded to the curved portion of the platform 1106. However, it should be understood that, depending on the implementation, the side panels 1114 may be any size and/or shape. In some implementations, the side panels 1114 may pivot about a hinge positioned at the back of the stand 104 providing an opening to an inner cavity of the stand 104. In some implementations, one or more side handles (not shown) may be positioned on the side panels 1114 which may allow a user to grab and open the side panels 1114.

The front panel 1116 may be positioned at the front of the stand 104 below the platform 1106. Depending on the implementation, the front panel 1116 may be positioned directly below or a distance below the platform 1106. In some implementations, the front panel 1116 may extend between the side panels 1114. In some implementations, one or more logos may be printed on the front panel 1116. In some implementations, the front panel 1116 may be substantially, fully, or partially flat. It should be understood that, depending on the implementation, the front panel 1116 may be any size and/or shape. In some implementations, the front panel 1116 may pivot about a hinge positioned on the bars 1104 or the platform 1106 providing an opening to an inner cavity of the stand 104. In some implementations, one or more front handles (not shown) may be positioned on the front panel 1116 which may allow a user to grab and open the front panel 1116. It should be understood that depending on the implementation, the side panel(s) 1114 and/or the front panel(s) 1116 may be made of any material or materials including, for example, fabric, synthetic fiber, modacrylic, glass fiber, polyester, nylon, polytetrafluoroethylene, flame-proof fiber, metal, alloy, steel, aluminum, iron, stainless steel, carbon steel, cast iron, 304 stainless steel, 430 stainless steel, 316 stainless steel, and/or any other suitable material.

In some implementations, the stand 104 may include four wheels 1118. Thus, the stand 104 may be moved by rolling the stand 104 on the wheels 1118 across a floor.

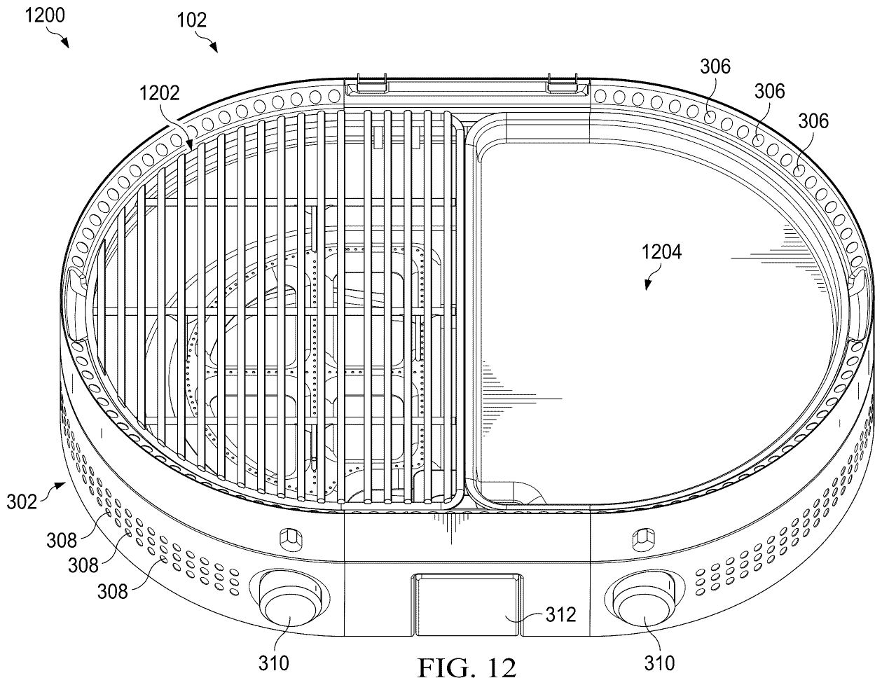

FIG. 12 is a perspective view 1200 of an example of a main body 102 of a cooking system 100, according to some aspects of the present disclosure. In some implementations, such as the example shown in FIG. 12, instead of a cook pan 304, the main body 102 may be equipped with griddle and grill capability. Thus, the main body may include a half-grill 1202 and a half cook pan 1204. In should be understood that the half cook pan 1204 may include any of the features or properties discussed with respect to the cook pan 304 with respect to FIGS. 3-9 and anywhere else in this disclosure. The half-grill 1202 is discussed further herein.

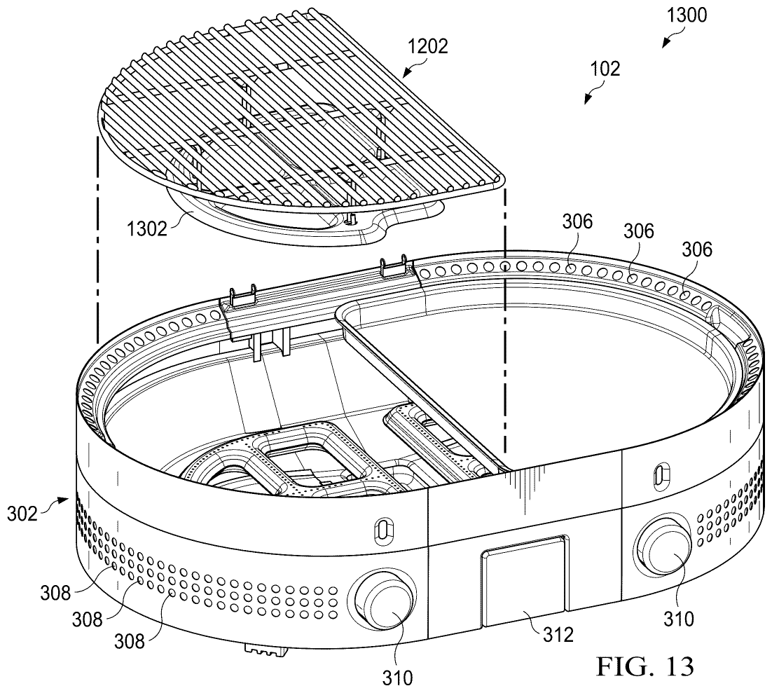

FIG. 13 is an exploded perspective view 1300 of an example of a main body 102 of a cooking system 100, according to some aspects of the present disclosure. As shown in the example of FIG. 13, the half-grill 1202 may be removed from the main body in a similar manner to the cook pan 304 and the half cook pan 1204. In some implementations, the half-grill 1202 may be inset into the burner housing 302 and may rest on the ledge 408. In some implementations, the top surface of the half-grill 1202 may be substantially coplanar or parallel with the highest portion of the burner housing 302. The half-grill 1202 may include a flavorizer 1302 which may also be referred to as a shield or safety shield. In some implementations, the flavorizer 1302 may be integral with the half-grill 1202. In some implementations, the flavorizer 1302 may be coupled to the half-grill 1202. In some implementations, the flavorizer 1302 may be suspended from the half-grill 1202. In some implementations, the flavorizer 1302 may be sized and shaped to substantially or fully correspond to the shape of the burners 404 and/or the alignment of the throat holes 426. However, it should be understood that the flavorizer 1302 may be any size or shape. In some implementations, outer edges of the flavorizer 1302 may curve downwardly such that the bottom of the flavorizer 1302 forms a concave shape. The flavorizer 1302 may be positioned above the burners 404 and/or throat holes 426 when the half-grill 1202 rests on the ledge 408 such that the flavorizer 1302 may shield the burners 404 and/or throat holes 426 from grease, oil, charred matter, food scraps, and/or any other debris dropping from dropping onto the burners 404 and or throat holes 426 potentially cause the throat holes 426 to clog or creating a fire hazard. The flavorizer 1302 may be positioned above the burners 404 and/or throat holes 426 when the half-grill 1202 rests on the ledge 408 such that the flavorizer 1302 may shield the user or other people from high flames coming from the burners 404.

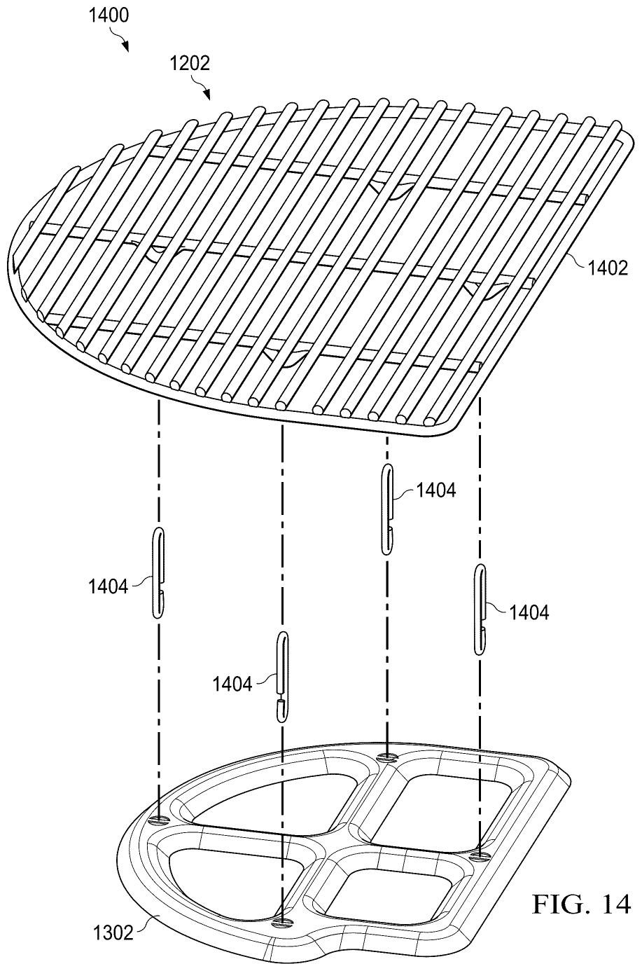

FIG. 14 is an exploded perspective view 1400 of an example of a grill 1202, according to some aspects of the present disclosure. The half-grill 1202 may further include a grate 1402 and one or more loops 1404. In some implementations, the half-grill 1202 may include three or four loops 1404 which may couple the flavorizer 1302 to the grate 1402 of the half-grill 1202. In some implementations, the flavorizer 1302 may rest of the bottom of the loops 1404 while the top of the loops 1404 clips onto a rod of the grate 1402. Thus, in some implementations, the flavorizer 1302 may be suspended from the grate 1402 and/or may be suspended a distance above the burners 404. In some implementations, the flavorizer 1302, the loops 1404, and/or the grate 1402 may be part of one-piece such that the half-grill 1202 is one integral piece.

It should be understood that, in some implementations, instead of a cook pan 304, the main body 102 may include a grill with substantially or fully the same outer perimeter as the cook pan 304 which may, depending on the implementation, include any features or properties discussed with respect to the half-grill 1202 with respect to FIGS. 12-14 and any other part of this disclosure.

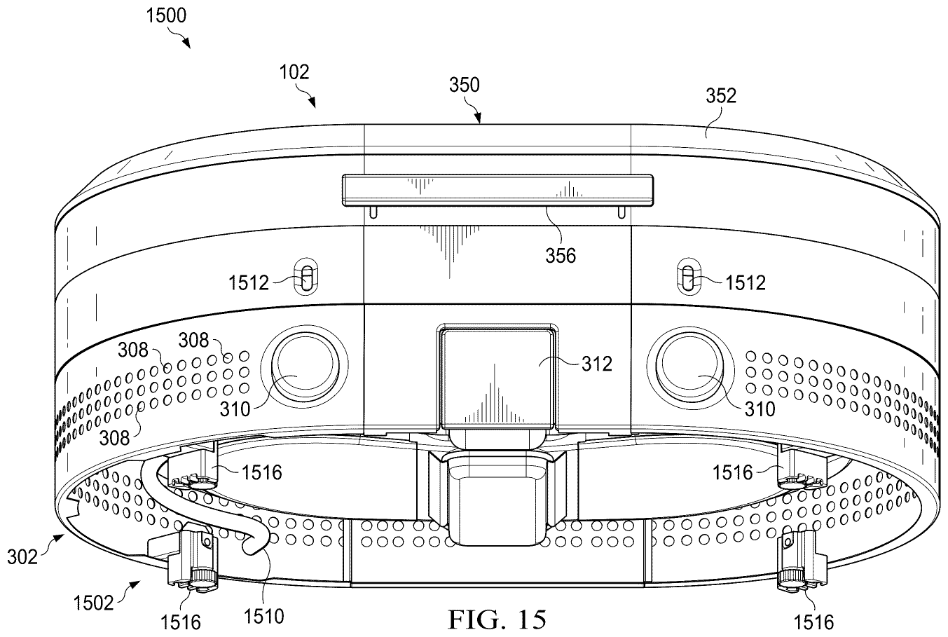

FIG. 15 is a bottom perspective view 1500 of an example of a main body 102 of a cooking system 100, according to some aspects of the present disclosure. In some implementations, the main body 102 may further include one or more feet 1516, one or more view holes 1512, and a fuel line 1510.

In some implementations, the main body may include four feet which may extend from the bottom of the main body 102. In some implementations, the feet 1516 may be one continuous piece. In some implementations, the height of the feet 1516 may be adjustable as discussed further herein.

In some implementations, the main body 102 may include two view holes 1512, which may be positioned at the front of the main body 102. In some implementations, the view holes 1512 may be positioned above or adjacent to the control knobs 310. The view holes 1512 may be positioned such that a user may look through the view holes 1512 and see the throat holes 426 of the burner 404. Thus, in some implementations, at least a portion of the view holes 1512 may be substantially or fully level with the burners 404 or at least a portion of the view holes may be positioned above the burners 404. It should be understood that depending on the implementation, the view holes may be any size or shape including, for example, slot-shaped, elliptical, circular, semi-circular, semi-elliptical, triangular, rectangular, square, polygonal, complex contoured, irregular, and/or any other shape. In some implementations, the view holes may be smaller than about ¼ inch lengthwise and/or may be configured to prevent flames from injuring the user's or a person's eye or other body parts. In some implementations, the view holes 1512 may be at least partially covered by a semi-translucent or translucent material including, for example, glass, polycarbonate, acrylic, polyethylene, polyvinyl chloride, metal mesh, alloy mesh, plastic mesh, and/or any other suitable material.

The fuel line 1510 may be positioned at least partially within the burner housing 302 and may provide fuel to a valve (not shown) at one end such that the piezo igniter 410 may ignite the fuel.

Some or all of the main body 102, the stand 104, 1000, and/or the feet 1516 may form a stabilizer 1502 configured to level the cook pan surface 704 of the cook pan 304. Thus, by adjusting the heights of the four feet 1516, the height and angle of the main body may be adjusted with respect to the platform 1006, 1106 and/or the stand 104, 1000. Thus, the height and angle of the cook pan 304 and/or the cook pan surface 704 may be adjusted and/or stabilized with respect to level, the platform 1006, 1106, and/or the ground.

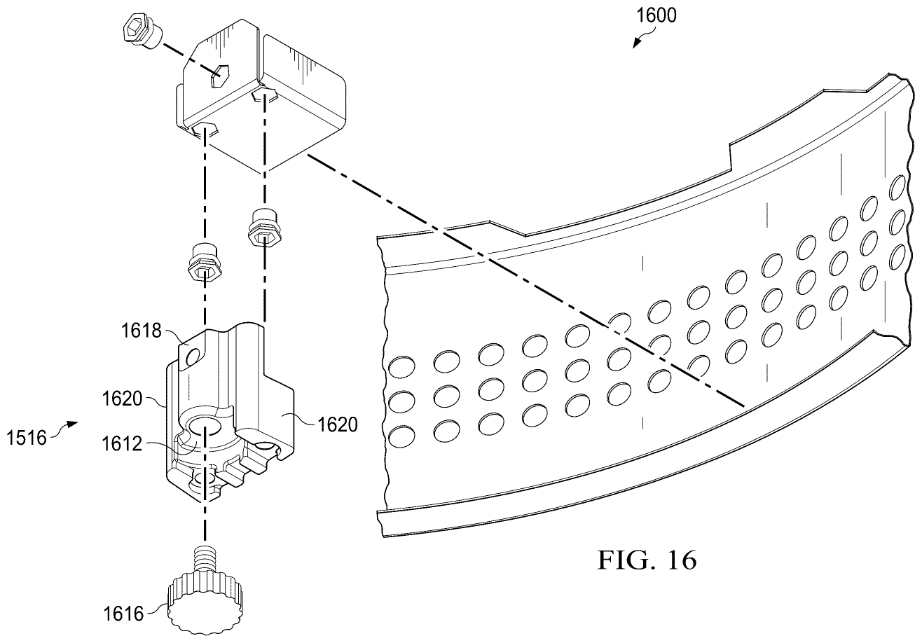

FIG. 16 is a perspective view 1600 of an example of a foot of a main body 102 of a cooking system 100, according to some aspects of the present disclosure. The feet 1516 may include some or all of a wall stop 1612, an adjustment knob 1616, a thread housing 1618, and/or an outer housing 1620.

The feet 1516 and main body 102 may rest at least partially on the adjustment knobs 1616. In some implementations, turning the adjustment knob 1616 may cause the heigh of the foot 1516 to increase or decrease depending on the direction of rotation of the adjustment knob 1616. The adjustment knob 1616 may be coupled to a threaded rod (not shown) which may couple with a threaded hole (not shown) within the thread housing 1618. Thus, rotating the adjustment knob 1616 may cause the threaded rod to engage with the threaded hole moving thus increasing or decreasing the size of the foot. However, it should be understood that depending on the implementation, the feet 1516 may include any mechanism for adjusting height including, for example, a wound spring, a jack, a crank, a pin and a column of holes, and/or any other suitable mechanism.

The outer housing 1620 may be positioned at least partially around the thread housing 1618. The wall stop 1612 may be positioned on the outer housing 1620 and/or the thread housing 1618 above the adjustment knob 1616. The wall stop 1612 may limit the minimum height of the foot 1516 by preventing the adjustment knob 1616 from moving further toward the far end of the thread housing 1618.

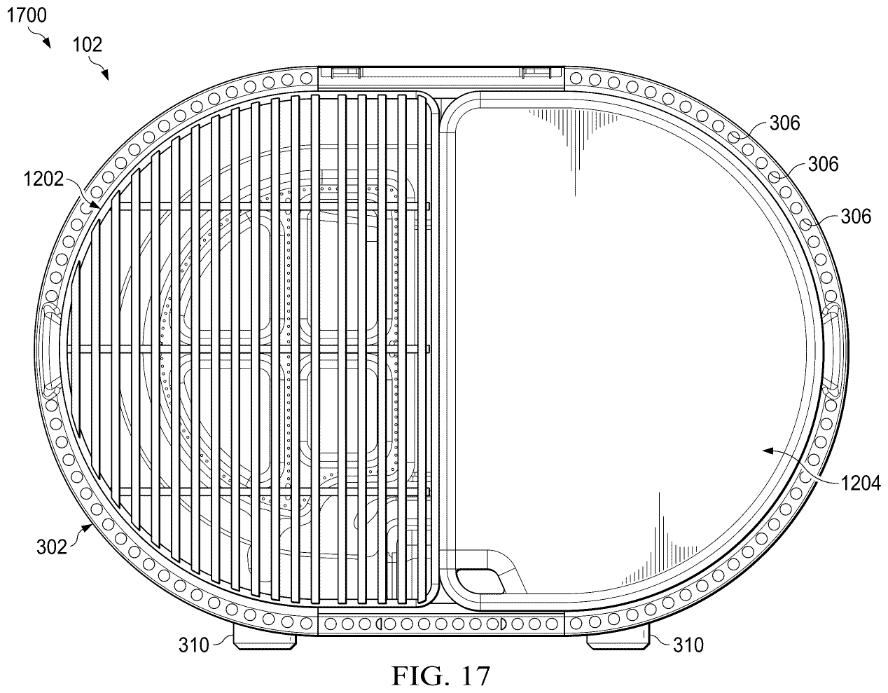

FIG. 17 is a top view 1700 of an example of a main body 102 of a cooking system 100, according to some aspects of the present disclosure. As shown in the example of FIG. 17, if a cross-section of the main body 102 is taken parallel to the page form this view 1700, the main body 102 may have an outer perimeter which may also be referred to as an outer contour or contour of the main body 102. It should be understood that this outer perimeter of the main body 102 may have any size and/or shape including, for example, a shape with rectangular lengthwise sides and semi-circular or semi-elliptical widthwise sides extending convexly outward, pill shaped, racetrack shaped, slot shaped, amphitheater shaped, elliptical, circular, rectangular, hexagonal, polygonal, complex contoured, irregular, and/or any other shape. Depending on the implementation, main body 102, burner housing 302, lid 350, cook pan 304, grill, half cook pan 1204, half-grill 1202, burner 404, platform 1006, platform 1106, and/or any other part of the cooking system 100 may at least partially have a corresponding, similar, same-contoured, and/or same outer perimeter as the outer perimeter of the main body 102.

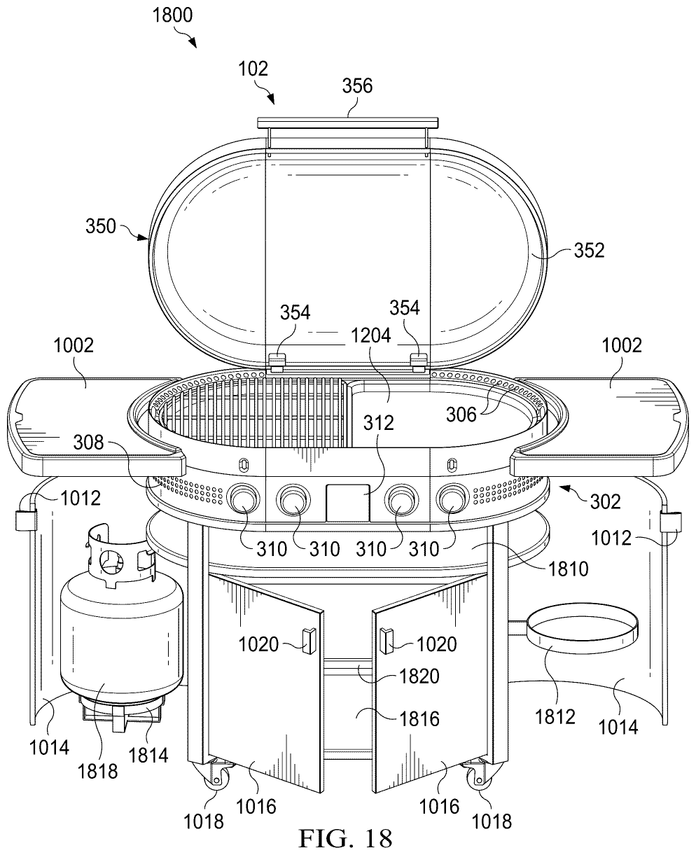

FIG. 18 is a front perspective view o1800 f an example of a cooking system 100, according to some aspects of the present disclosure. The cooking system may further include some or all of a top shelf 1810, a trash-can holder 1812, a fuel-tank holder 1814, a bottom shelf 1816, a fuel tank 1818, and/or a middle shelf 1820.

In some implementations, the front plate 1010 (not shown in FIG. 18 but shown in FIG. 10) may be hingedly connected to the stand 1000. Depending on the implementation, the front plate 1010 may be coupled to one or more hinges (not shown) which may be positioned at the bottom, top, or either side of the front plate 1010. Thus, the front plate may be pivoted about the one or more hinges such that the top shelf 1810 may be exposed.

In some implementations, the front doors 1016 may be hingedly connected to the stand 1000. The front doors 1016 may be coupled to one or more hinges (not shown) which may be positioned at the outer edge of the front doors 1016 such that the front doors 1016 may pivot outwardly exposing the middle shelf 1820 and the bottom shelf 1816. Thus, the front plate may be pivoted about the one or more hinges such that the top shelf 1810 may be exposed.

The trash-can holder 1812 may be coupled to the inner wall of the right side door 1014 or it may be pivotable about a hinge (not shown) such that it may swing outwardly when the right side door 1014 is open.

The fuel-tank holder, which may also be referred to as a fuel-tank loader, may be coupled to the inner wall of the left side door 1014 or it may be pivotable about a hinge (not shown) such that it may swing outwardly when the left side door 1014 is open. An old fuel tank 1818 may be removed from the fuel-tank holder and replaced with a new one and the fuel-tank holder may be pivoted back into within the stand 1000, loading the new fuel tank. In some implementations, instead of pivoting, the fuel-tank holder 1814 may be positioned on a track which may allow the fuel-tank holder 1814 to slide inwardly and outwardly when the left side door 1014 is open.

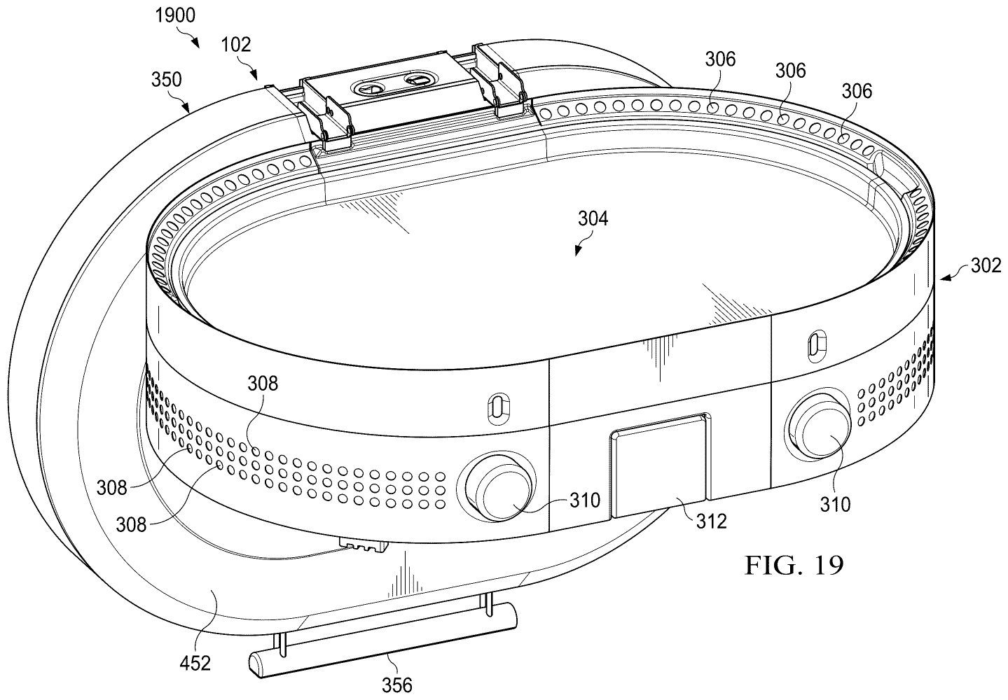

FIG. 19 is a perspective view 1900 of an example of a main body 102 of a cooking system 100, according to some aspects of the present disclosure. In some implementations, the hinges 354 may allow the lid 350 to pivot up to 270 degrees with respect to the cook pan 304 and/or the cook pan surface 704 as is discussed further herein. Thus, in some implementations, the lid 350 may transition between a closed position, a venting position, in which the lid 350 rotates about the hinges 354 to be at least 65 degrees to 90 degrees from the cook pan surface 704, and a breakout position, in which the lid 350 rotates about the hinge to be at least 210 degrees to 270 degrees from the cook pan surface 704.

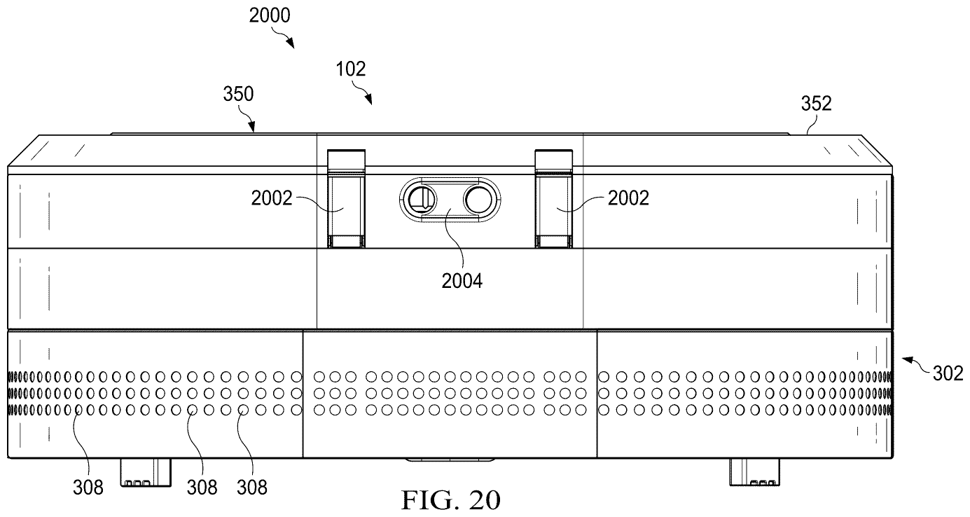

FIG. 20 is a back perspective view 2000 of an example of a main body 102 of a cooking system 100, according to some aspects of the present disclosure. In some implementations, the main body 102 may further comprise one or more two-stage hinges 2002 and a spring-loaded pin actuator 2004.

In some implementations, the main body 102 may further include two two-stage hinges 2002 which may couple the lid 350 to the burner housing 302. The two-stage hinges 2002 and the spring-loaded pin actuator 2004 are discussed further herein.

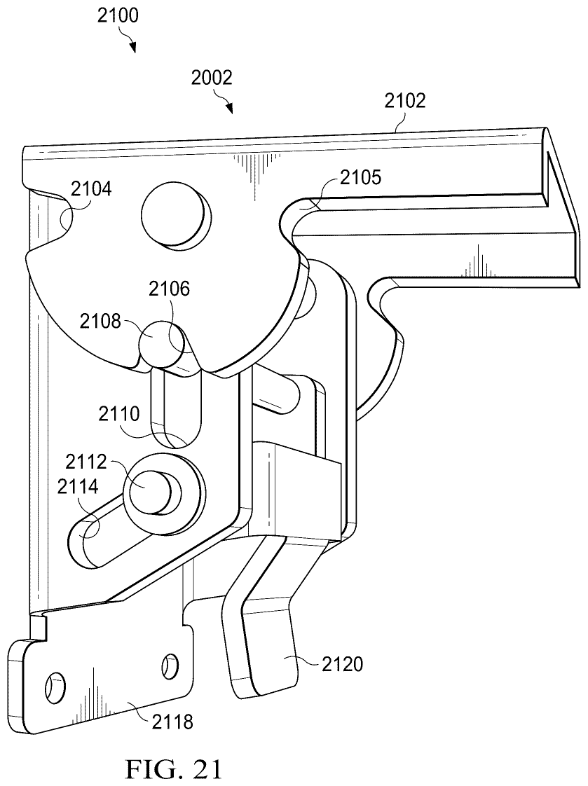

FIG. 21 is a side perspective view 2100 of an example of a hinge 2002, according to some aspects of the present disclosure. In some implementations, the two-stage hinge 2002 may include some or all of a lid coupler 2102, a 270-degree notch 2104, a 0-degree notch 2105, a 90-degree notch 2106, a pin 2108, a first slot 2110, a second pin 2112, a second slot 2114, a body coupler 2118, and an adjustable tab 2120.

The lid coupler 2102 may couple to the lid 350 and the body coupler 2118 may couple to the burner housing 302 by positioning a portion of the burner housing between the body coupler 2118 and the adjustable tab 2120 by adjusting the position of the second pin 2112 in the second slot 2114.

In some implementations the spring-loaded pin actuator 2004 may be actuated by a user inserting a finger in each of the holes of the spring-loaded pin actuator 2004 and pinching inwardly. When the spring-loaded pin actuator 2004 is actuated, the pin 2108 moves downwardly into the lower portion of the slot 2110 allowing the lid coupler 2102 to rotate freely. Thus, when the pin 2108 is actuated, the user may adjust the lid 350 and the lid coupler 2102 between 0 degrees and 270 degrees. By releasing the spring-loaded pin actuator 2004, the pin 2108 will gain potential energy from the spring (not shown) in the spring-loaded pin actuator 2004 causing the pin 2108 to experience an upward force. Thus, when the pin 2108 is unactuated and the lid coupler 2102 rotates such that one of the 0-degree notch 2105, the 90-degree notch 2106, or the 270-degree notch 2104, are aligned with the 2108, the pin 2108 will spring upwardly locking the two-stage hinge 2002 in place. Thus, the user may transition continuously between the 0-degree notch 2105, the 90-degree notch 2106, or the 270-degree notch 2104 by holding the spring-loaded pin actuator 2004 in the actuated position.

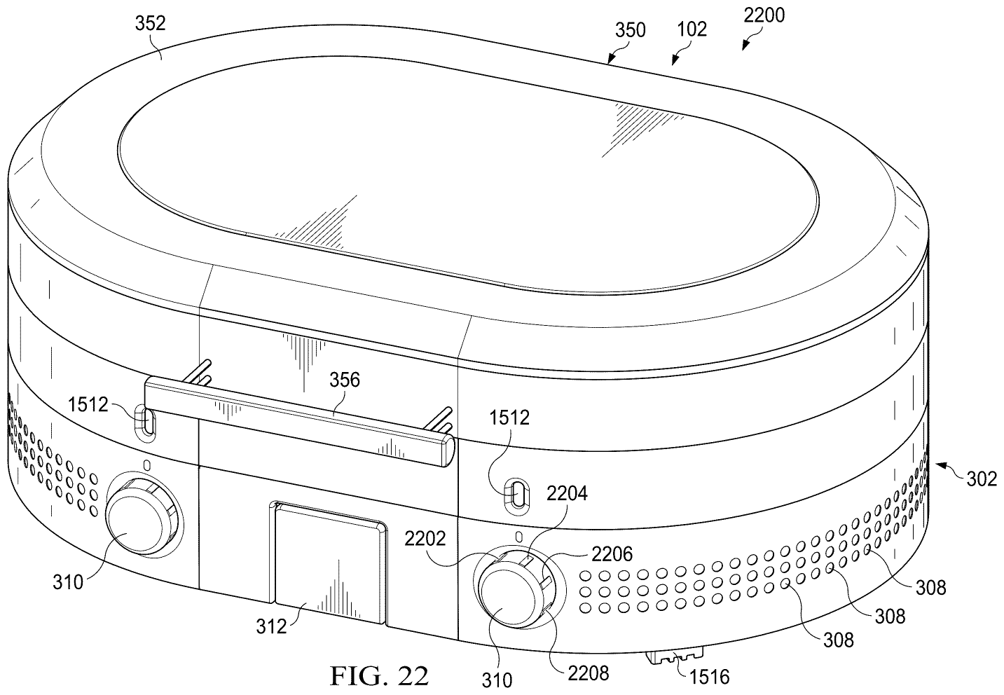

FIG. 22 is a perspective view 2200 of an example of a main body 102 of a cooking system 100, according to some aspects of the present disclosure. The control knobs 310 may be a dual-action control and/or may include an off setting 2202, an ignition setting 2204, a high setting 2206, a medium setting 2208, and a low setting (not shown). The off-setting 2202 may cause no fuel to flow to the burners 404. The ignition setting 2204 may cause the piezo igniter 410 to ignite the fuel. The high setting 2206 may cause a first rate of fuel to flow to the burners 404. The medium setting 2208 may cause a second rate of fuel to flow to the burners 404. The low setting may cause a third rate of fuel to flow to the burners 404. The first rate of fuel may be greater than the second rate of fuel and the second rate of fuel may be greater than the third rate of fuel. The control knob may be rotated continuously or discretely from the off-setting 2202 to the high setting 2206, the medium setting 2208, and/or the low setting to simultaneously actuate the piezo igniter 410 and light the fuel in the burners 404.

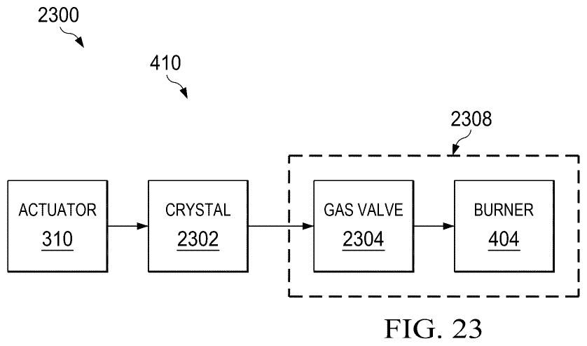

FIG. 23 is a block diagram of an example of an ignition system 2300, according to some aspects of the present disclosure The piezo igniter 410 may include an actuator 310, a crystal 2302, and a fuel distributer 2308. The fuel distributor may include a gas valve 2304 and one or more burners 404. In some implementations, the actuator 310 may be a control knob; however, it should be understood that the actuator 310 may be any type of actuator discussed herein. The actuator may mechanically actuate an electromechanical actuator including, for example, a hammer (not shown). In response to the actuation, the electromechanical actuator may strike the crystal 2302 causing the crystal to spark and light the fuel at the gas valve 2304. The ignited fuel may travel into the burner(s) 404 and create a flame at the throat holes 426.

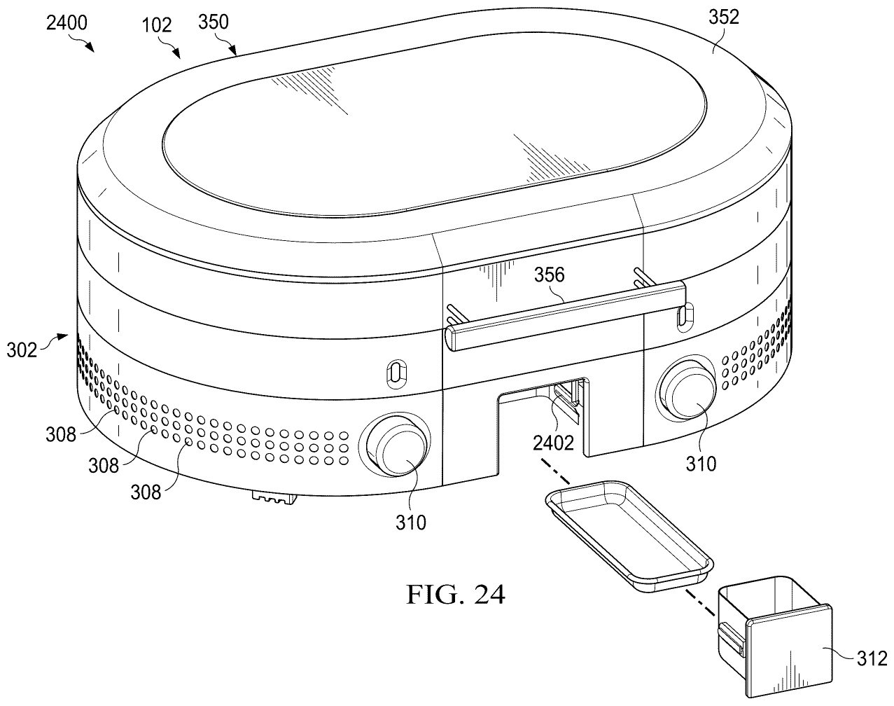

FIG. 24 is a perspective view 2400 of an example of a main body 102 of a cooking system 100, according to some aspects of the present disclosure. In some implementations, the grease trap 312 may be positioned on a track 2402 which may allow the grease trap 312 to slide out from within the burner housing 302. In some implementations, the grease pan 412 may be positioned on a second track (not shown) which may allow the grease pan 412 to slide out from within the burner housing 302.

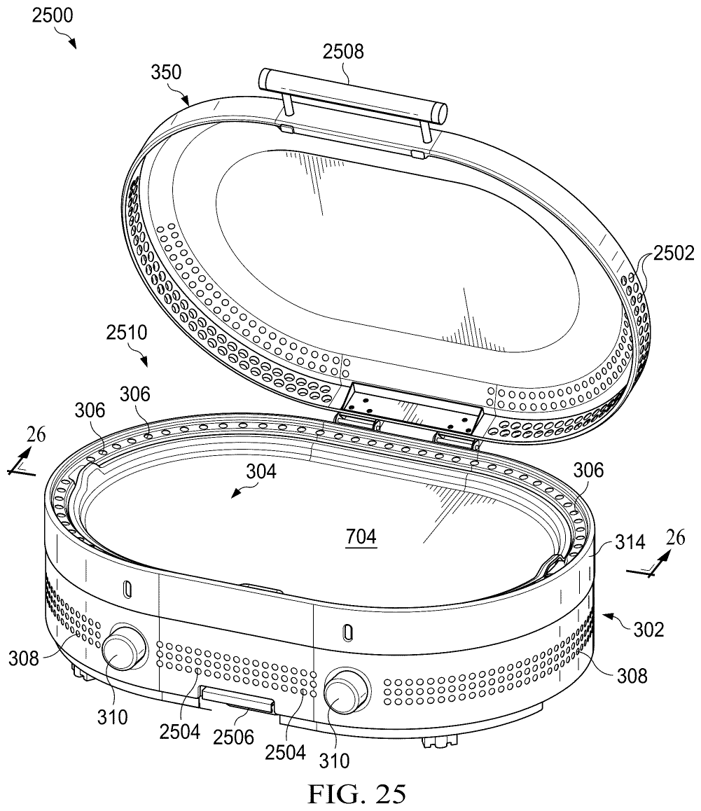

FIG. 25 is a perspective view of an example of a main body 2510 of a cooking system 2500, according to some aspects of the present disclosure. The cooking system 2500 may include any of the features of the cooking system 100 disclosed herein and the main body 2510 may include any of the features of the main body 102 disclosed herein. In some aspects, the lid 350 may include one or more vents or ventilation openings 2502. The one or more ventilation openings 2502 may release air from the cavity between the cook pan 304 and the lid 350 even when the lid 350 is closed. Thus, in some examples, the ventilation openings 2502 may be outlets. In some aspects, the lid 350 may include a handle 2508, which a user may use to move the lid 350.

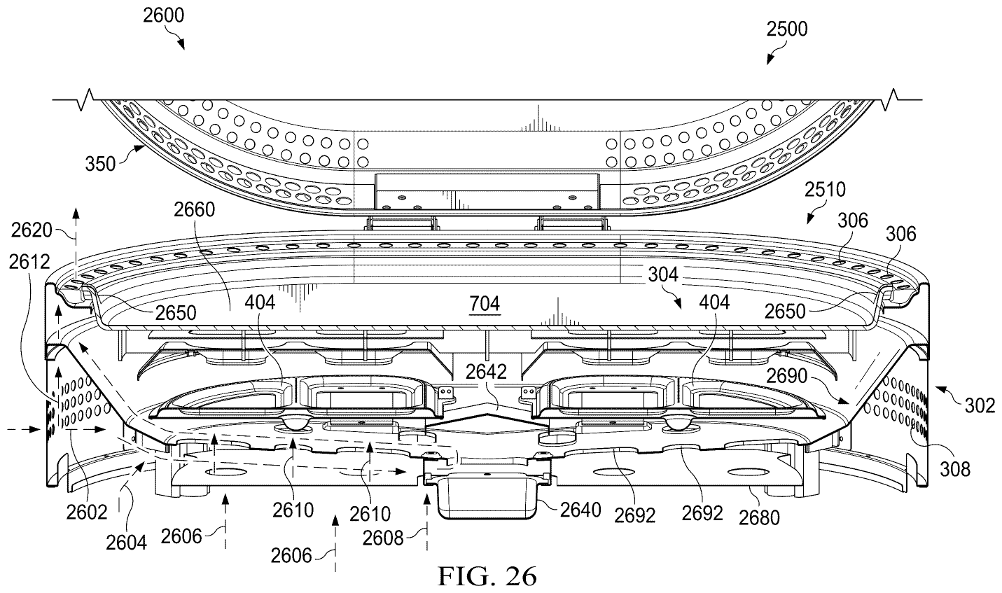

In some aspects, the front of the main body 2510 may include one or more front vents or vent openings 2504. These may be intake vents in some implementations. Thus, in some aspects, the tray 2640 (shown in FIG. 26) may collect grease instead of the grease trap 312 allowing for the opening for inserting the tray 2640 to be positioned lower on the front of the main body 2510 than the opening for inserting the grease trap 312. In some aspects, the tray 2640 may include a flange 2506, which a user may use to grab the tray 2640 and slide the tray 2640 out from under the main body 2510. The tray 2640 may collect grease, food droppings, and/or other debris which may fall from, for example, the cook pan 304, 1204 and/or the cooking grate 1202.

FIG. 26 is a cross-sectional perspective view 2600 of an example of a main body 2510 of a cooking system 2500, according to some aspects of the present disclosure. In some aspects, FIG. 26 may illustrate the airflow within the main body 2510. In some aspects, the cooking system 2500 may include a cook pan 2660, which may include any of the features of the cook pan 304 disclosed herein. In some aspects, the main body 2510 may include the tray 2640, a flame shield 2642, bottom plate 2680, a burner dish 2690, and/or one or more edge flanges 2692. The cook pan 2660 may include one or more cook pan handles 2650.

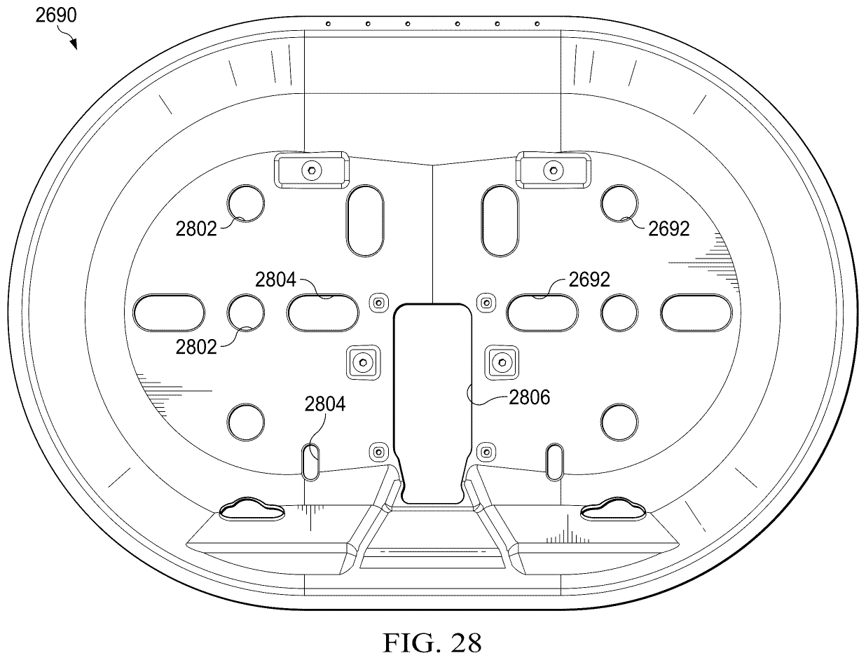

The airflow within the main body 2510 may include first lateral inlet airflow 2602, second lateral inlet airflow 2604, lower inlet airflow 2606, central inlet airflow 2608, opening airflow 2610, first channel airflow 2612, and outlet airflow 2620. The first lateral inlet airflow may enter the main body 2510 through the one or more vent openings 308. The second lateral inlet airflow may enter the main body 2510 through the bottom of the main body 2510. In some aspects, some of the first lateral inlet airflow 2602 may flow into the first channel 522 and the first gap 506 and become first channel airflow 2612 and/or some of the first lateral inlet airflow 2602 may converge with second lateral inlet airflow 2604 and flow between the bottom plate 2680 and the burner dish 2690. The lower inlet airflow may flow through one or more openings in the bottom plate 2680 and converge with the airflow between the bottom plate 2680 and the burner dish 2690. The central inlet airflow may flow through the second channel 524 and the second gap 512 and converge with the airflow between the bottom plate 2680 and the burner dish 2690. The airflow between the bottom plate 2680 and the burner dish 2690 may become opening airflow 2610 as it flows through one or more circular openings 2802 (shown in FIG. 28), one or more slot-shaped openings 2804 (shown in FIG. 28), one or more tray openings 2806 (shown in FIG. 28), and/or any other opening in the burner dish 2690 into the space between the burner dish 2690 and the cook pan 2660 which includes the burners 404. The first channel airflow 2612 may converge with airflow within the space between the burner dish 2690 and the cook pan 2660 and exit the main body 2510 through the one or more upper vent openings 306 as outlet airflow 2620. When the lid 350 is closed, outlet airflow 2620 may outlet into the cavity between the cook pan 2660 and the lid 350 and exit from the one or more ventilation openings 2502. The flame shield 2642 may be configured to at least partially separate the tray 2640 from the burners 404.

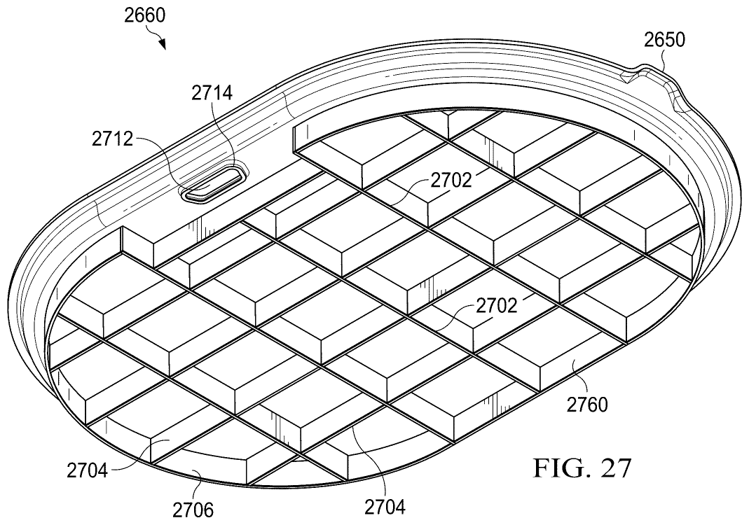

FIG. 27 is a perspective view of an example of a cook pan 2660, according to some aspects of the present disclosure. The cook pan 2660 may include a grease drain 2712, a grease drain flange 2714, and/or a truss 2760. The truss 2760 may distribute heat from the burners 404 across the cook pan 2660, structurally support the cook pan 2660 (e.g., prevent or reduce bending and/or bowing of the cook pan 2660), and/or elevate the cook pan 2660 relative to the burners 404. The truss 2760 may include one or more first members 2702, one or more second members 2704, and/or an outer ring 2706. In some aspects, the one or more first members 2702 and the one or more second members 2704 may form a substantially gridded structure in which the one or more first members 2702 are entirely or substantially perpendicular to the one or more second members 2704. In some aspects, the outer ring 2706 may form the outer perimeter of the truss 2760 and/or the one or more first members 2702 and the one or more second members 2704 may extend entirely or partially between points on the outer ring 2706. In some aspects, the rest of the cook pan 2660 may be removable from the truss 2760. In some aspects, the truss 2760 may be fixed to the cook pan 2660 including, for example, fixed by welding.

The grease drain 2712 may include any of the features of the grease drain 812 disclosed herein and/or may be configured to allow grease to drain from the upper surface 704 of the cook pan 2660 onto a portion of the burner dish 2690 and into the tray 2640. The grease drain 2712 may be spaced from the edge of the cook pan 2660, extend through the upper surface 704 of the cook pan 2660, and/or may be positioned closer to the front edge of the cook pan 2660 than the back edge of the cook pan 2660.

FIG. 28 is a top view of an example of a burner dish 2690, according to some aspects of the present disclosure. The burner dish 2690 may include any of the features of the burner dish 406 disclosed herein and may include one or more circular openings 2802, one or more slot-shaped openings 2804, and/or one or more tray openings 2806. In some aspects, the one or more circular openings 2802, the one or more slot-shaped openings 2804, and/or the one or more tray openings 2806 may each include an edge flange 2692 which may extend upwardly from the burner dish 2690 and may prevent grease, food droppings, and/or other debris from falling from the burner dish 2690 into the one or more circular openings 2802, the one or more slot-shaped openings 2804, and/or the one or more tray openings 2806.

It should be understood that although implementations in this disclosure may be referred to with words such as “top,” “bottom,” “side,” “front,” “back,” “upper,” lower,” “upwardly,” and “downwardly” all implementations disclosed herein may be configured in any orientation and/or direction.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A cooking system comprising:
a portable gas-fired cooking apparatus;
a stand comprising a top surface and configured to support the portable gas-fired cooking apparatus, the stand comprising a plurality of supports spaced a distance apart from the top surface, the stand configured to support the portable gas-fired cooking apparatus at at least four points of contact, the stand further comprising a plurality of members extending upwardly; and
wherein the portable gas-fired cooking apparatus is configured to rest on the plurality of supports between the plurality of members.

2. The cooking system of claim 1, wherein the plurality of supports comprises two supports and wherein the plurality of members comprises at least four members extending from a plane parallel to the top surface, each of the supports extending from one of the at least four members to another of the at least four members and having a support surface facing upwardly.

3. The cooking system of claim 1, wherein the plurality of supports comprises two beams and wherein the plurality of members comprises four rods, each of the beams extending from one of the four rods to another of the four rods and having a support surface facing upwardly, each of the four rods being positioned at least partially adjacent to the portable gas-fired cooking apparatus, each of the four rods being positioned below a highest portion of the portable gas-fired cooking apparatus;
wherein the portable gas-fired cooking apparatus comprises four feet, the four feet supported on upwardly facing surfaces of the beams, the portable gas-fired cooking apparatus being only supported by the four feet; and
wherein the stand further comprises four wheels.

4. The cooking system of claim 1, wherein the portable gas-fired cooking apparatus rests on the plurality of supports without being fixed to the plurality of supports in a manner that the portable gas-fired cooking apparatus is configured to be upwardly removable from the stand.

5. The cooking system of claim 4, wherein the plurality of members prevents the portable gas-fired cooking apparatus from being laterally removable from the stand.

6. The cooking system of claim 1, wherein the plurality of members is spaced from a side of the portable gas-fired cooking apparatus.

7. The cooking system of claim 1, wherein the stand further comprises at least one collapsible shelf.

8. An adjustable cooking apparatus with an integrated stabilizer comprising:
a main body, the integrated stabilizer coupled to the main body;
a cook pan supported by the main body, the cook pan having a cook pan surface; and
a stand configured to support the main body, the integrated stabilizer configured to adjust an angle and a height of the cook pan surface relative to level while the cook pan is being supported by the stand.

9. The adjustable cooking apparatus of claim 8, wherein the integrated stabilizer further comprises a plurality of actuable knobs, the actuable knobs configured to change the height of a portion of the main body.

10. The adjustable cooking apparatus of claim 8, wherein the integrated stabilizer further comprises four feet extending downwardly from the main body, the four feet each comprising:
a threaded rod configured to change elevation and change the height of a portion of the main body;
a threaded hole configured to receive the threaded rod; and
a knob configured to adjust an elevation of the threaded rod and configured to rest on the stand.

11. The adjustable cooking apparatus of claim 9, wherein the plurality of actuable knobs comprises a plurality of twistable knobs which are threadably coupled to the adjustable cooking apparatus.

12. The adjustable cooking apparatus of claim 9, wherein the plurality of actuable knobs is configured to be independently adjustable from each other.

13. The adjustable cooking apparatus of claim 12, wherein the plurality of actuable knobs is configured to be independently adjustable from each other in a manner that the height of each of the plurality of actuable knobs is configured to vary with respect to each other.

14. The adjustable cooking apparatus of claim 8, wherein the integrated stabilizer rests on the stand without being fixed to the stand in a manner that the main body is configured to be upwardly removable from the stand.

15. A stand for a portable cooking apparatus with integrated gas-tank loading, the stand comprising:
a main body;
a support structure configured to support the main body;
a main cavity positioned within the support structure;
at least one fuel tank support positioned within the main body; and
an integrated loading member configured to pivot and being hingedly connected to the support structure, the integrated loading member configured to move between an open position and a closed position, wherein, when transitioning from the open position to the closed position the integrated loading member is configured to move a fuel tank into the main cavity of the stand.

16. The stand of claim 15, further comprising a fuel line at least partially positioned within the stand and being accessible to a user in the open position.

17. The stand of claim 15, further comprising:
a door coupled to the integrated loading member and configured to close at least a portion of the main cavity of the stand in the closed position, the integrated loading member further comprising a platform; and
a fuel tank configured to be positioned on the platform and configured to rotate with the integrated loading member.

18. The stand of claim 15, wherein the integrated loading member is coupled to a door, the door configured to pivot between the open position and the closed position.

19. The stand of claim 15, wherein the integrated loading member is hingedly coupled to a vertical member of the support structure and is configured to pivot about the vertical member.

20. The stand of claim 15, wherein the integrated loading member further comprises a securement structure, the securement structure configured to releasably secure the fuel tank to the integrated loading member.
